(19) United States
(12) Patent Application Publication
(10) Pub. No.: US 2009/0297810 A1
(43) Pub. Date: Dec. 3, 2009

(54) Polyethylene Films and Process for Production Thereof

(76) Inventors: David M. Fiscus, Houston, TX (US); Danny Van Hoyweghen, Heverlee (BE); X. Christinia Lu, Missouri City, TX (US); Alan A. Galuska, Glen Gardener, NJ (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/130,135

(22) Filed: May 30, 2008

(51) Int. Cl. B32B 27/32; B29C 45/16

(52) U.S. Cl. 428/220; 264/328.1

(57) ABSTRACT

This invention relates to a polyethylene film having a MD 1% Secant Modulus of 220 MPa or more and an MD Elmendorf Tear of Y g/micron, where Y≧−0.4515(Dart Drop in g/micron)+33.3 g/microns, wherein the MD Elmendorf tear is at least 11.8 g/micron.

### PRIORITY CLAIM

This application claims priority to U.S. Ser. No. 11/959,078, filed Dec. 18, 2007.

### STATEMENT OF RELATED CASES

This application relates to U.S. Ser. No. 11/789,391, filed Apr. 24, 2007, which claims priority to and the benefit of U.S. Ser. No. 60/809,509, filed May 31, 2006. This application relates to U.S. Ser. No. 11/788,004, filed Apr. 18, 2007, which claims priority to and the benefit of U.S. Ser. No. 60/798,382, filed May 5, 2006.

### FIELD OF THE INVENTION

This invention relates to polyethylene resins and films made therefrom.

### BACKGROUND OF THE INVENTION

Ethylene-based polymers are generally known in the art. For example, polymers and blends of polymers have typically been made from a linear low density polyethylene prepared using Ziegler-Natta and/or metallocene catalyst in a gas phase process.

Films made from conventional Ziegler-Natta catalyzed linear low density polyethylene (Z-N LLDPE) are known to have favorable physical properties such as stiffness and good Elmendorf tear strength. However, films prepared with metallocene catalyzed LLDPE often suffer from drawbacks such as low tear strength, in both the machine and transverse film directions, compared to films prepared with Z-N LLDPE. Thus, the film industry has sought metallocene catalyzed film resins that exhibit favorable tear properties similar to, or better than, those of films prepared with Ziegler-Natta catalyzed resins.

The film industry is still in search of methods and compositions that overcome these shortcomings and provide improved physical properties, improved processability, and an improved balance of properties.

U.S. Pat. No. 6,242,545 describes a process for the polymerization of monomers utilizing hafnium transition metal metallocene-type catalyst compound. The patent also describes the catalyst compound, which comprises at least one cyclopentadienyl ligand including at least one linear or isoalkyl substitutent of at least three carbon atoms.

U.S. Pat. Nos. 6,248,845 and 6,528,597 describe single reactor processes for the polymerization of monomers utilizing a bulky ligand hafnium transition metal metallocene-type catalyst compounds. These patents also describe an ethylene polymer composition produced by using bulky ligand hafnium metallocene-type catalysts.

U.S. Pat. No. 6,956,088 describes metallocene-catalyzed polyethylenes having relatively broad composition distribution and relatively broad molecular weight distribution. Specifically, U.S. Ser. No. 6,956,088 discloses films made from ethylene polymers made using a bis(n-propylcyclopentadienyl) hafnium dichloride and methylalumoxane. These films do not have good stiffness and good Elmendorf tear and good dart drop.

U.S. Pat. No. 6,936,675 and U.S. patent application Ser. Nos. 11/098,077 and 11/135,882 describe polyethylene films produced from a polymer obtained using a hafnium-based metallocene catalyst. Methods for manufacturing the films are also described.

US 2008/0038533 (specifically examples 46, 47 and 48) discloses films made from polyethylene made from catalyst systems disclosed in U.S. Pat. No. 6,956,088. These films do not have an MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron.

U.S. Pat. No. 7,179,876 and U.S. Pat. No. 7,157,531 disclose films made from ethylene polymers made using a bis(n-propylcyclopentadienyl)hafnium metallocene and methylalumoxane. These films do not have an MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron.

While many prior art documents describe processes and polymers using the same monomers as those described herein and similar processes to those described herein, none describe films having an MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron. This invention also provides films having improved physical properties, improved processability, and improved balance of properties.

### SUMMARY OF THE INVENTION

This invention relates to a polyethylene film having an MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron.

### BRIEF DESCRIPTION OF THE FIGURES

FIG. 1 is a graph of MD Elmendorf Tear versus Dart Drop of films 4, 12,13, 14, 16, 18, 21, and 22.

FIG. 2 is a graph of MD Elmendorf Tear versus Dart Drop of inventive films 2, 5 to 9, 11, 17, 19, and 20.

FIG. 3 is a graph of MD Elmendorf Tear versus Dart Drop of certain films described in U.S. Pat. No. 6,956,088.

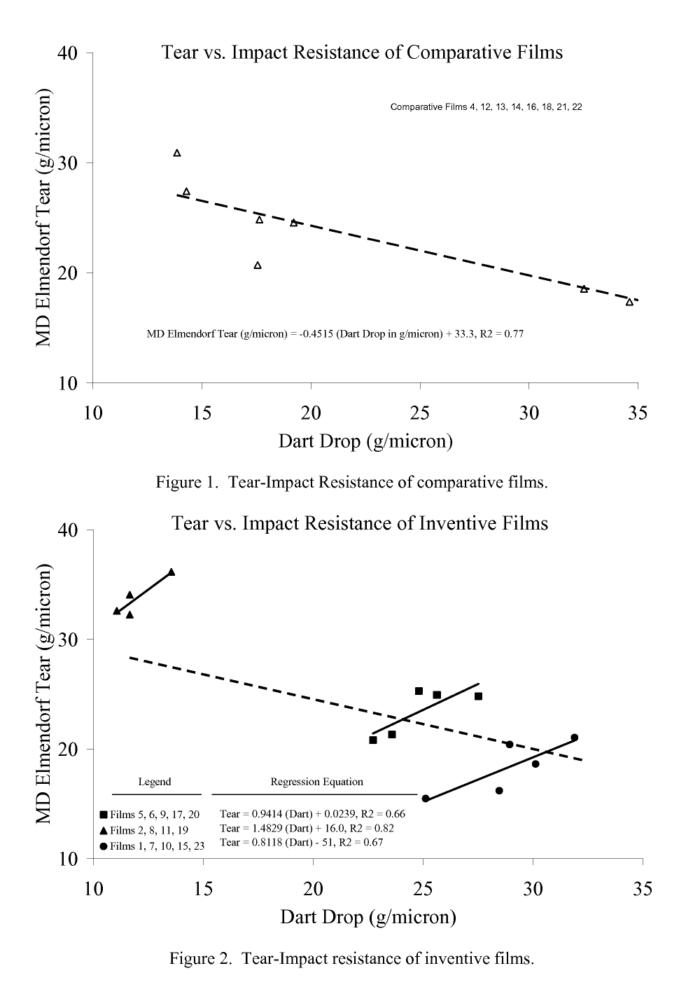

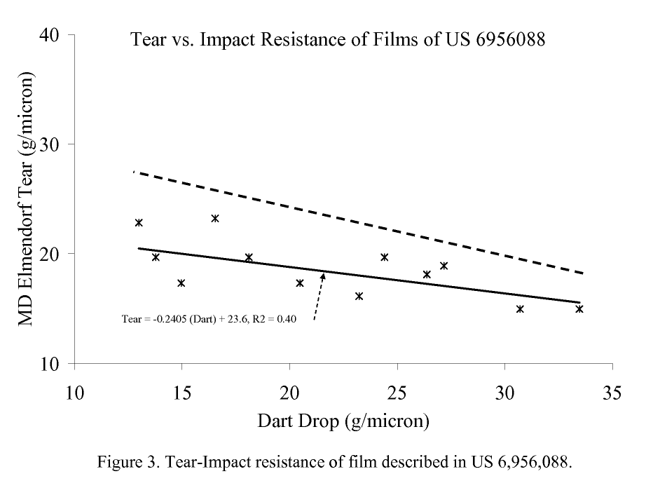

### DETAILED DESCRIPTION OF THE INVENTION

For the purposes of this disclosure, wt % is weight percent. As used herein, the terms “low density polyethylene, “LDPE” “linear low density polyethylene, and “LLDPE” refer to a polyethylene homopolymer or copolymer having a density from 0.910 g/cm³ to 0.945 g/cm³. The terms “polyethylene” and “ethylene polymer” mean a polyolefin comprising at least 50 mol % ethylene units. Preferably the “polyethylene” and “ethylene polymer” comprise at least 60 mol %, preferably at least 70 mol %, preferably at least 80 mol %, even preferably at least 90 mol %, even preferably at least 95 mol % or preferably 100 mole % ethylene units; and have less than 15 mol % propylene units. An “ethylene elastomer” is an ethylene copolymer having a density of less than 0.86 g/cm³. An “ethylene plastomer” (or simply a “plastomer”) is an ethylene copolymer having a density of 0.86 to less than 0.91 g/cm³. A “high density polyethylene” (“HDPE”) is an ethylene polymer having a density of more than 0.945 g/cm³ or more. Polymers having more than two types of monomers, such as terpolymers, are also included within the term “copolymer” as used herein.

Molecular weight distribution (“MWD”) is M_{w}/Mₙ. Measurements of weight average molecular weight (M_{w}), number average molecular weight (Mₙ), and z average molecular weight (Mz) are determined by Gel Permeation Chromatography as described in Macromolecules, Vol. 34, No. 19, pg. 6812 (2001) which is fully incorporated herein by reference. In such cases, a High Temperature Size Exclusion Chromatograph (SEC, Waters Alliance 2000), equipped with a differential refractive index detector (DRI) equipped with three Polymer Laboratories PLgel 10 mm Mixed-B columns is used. The instrument is operated with a flow rate of 1.0 cm³ /min, and an injection volume of 300 μL. The various transfer lines, columns and differential refractometer (the DRI detector) are housed in an oven maintained at 145° C. Polymer solutions are prepared by heating 0.75 to 1.5 mg/mL of polymer in filtered 1,2,4-Trichlorobenzene (TCB) containing ˜1000 ppm of Butylated Hydroxy Toluene (BHT) at 160° C. for 2 hours with continuous agitation. A sample of the polymer containing solution is injected into to GPC and eluted using filtered 1,2,4-Trichlorobenzene (TCB) containing ˜1000 ppm of BHT.

The separation efficiency of the column set is calibrated using a series of narrow MWD polystyrene standards reflecting the expected Mw range of the sample being analyzed and the exclusion limits of the column set. Seventeen individual polystyrene standards, obtained from Polymer Laboratories (Amherst, Mass.) and ranging from Peak Molecular Weight (Mp) ˜580 to 10,000,000, are used to generate the calibration curve. The flow rate is calibrated for each run to give a common peak position for a flow rate marker (taken to be the positive inject peak) before determining the retention volume for each polystyrene standard. The flow marker peak position is used to correct the flow rate when analyzing samples. A calibration curve (log(Mp) vs. retention volume) is generated by recording the retention volume at the peak in the DRI signal for each PS standard, and fitting this data set to a 2nd-order polynomial. The equivalent polyethylene molecular weights are determined by using the Mark-Houwink coefficients shown in Table 1.

TABLE 1
Mark-Houwink coefficients

| Material | k (dL/g) | A |
|---|---|---|
| PS | 1.75 × 10−4 | 0.67 |
| PE | 5.79 × 10−4 | 0.695 |

Composition distribution breadth index (“CDBI”) is defined as the weight percent of the copolymer molecules having comonomer content within 50% of the median total molar comonomer content. The CDBI of a copolymer is determined utilizing well known techniques for isolating individual fractions of a sample of the copolymer calculated according to PCT Patent Application WO 93/03093. One such technique for isolating individual fractions is Temperature Rising Elution Fraction (TREF), as described in Wild, et al., J. Poly. Sci. Poly. Phys. Ed., Vol. 20, pg. 441 (1982) and U.S. Pat. No. 5,008,204, which are fully incorporated herein by reference. In such cases, a commercial analytical TREF instrument (Model 200, PolymerChar S.A.) is used. The polymer sample is dissolved into a solvent, crystallized onto a support and eluted from the support with an additional amount of the same solvent using a high precision pump as the temperature of the mixture is increased. Polymer chains fractionate by differences in their crystallization and melting behavior in the solvent. The concentration of eluting polymer is monitored with an infrared detector. A polymer sample is dissolved in 1,2-dichlorobenzene (2-5 mg of sample per milliter of solvent at 160° C. for 60 minutes) and the resulting solution (0.5 mL) introduced into a packed column to crystallize: stabilized (maintain temperature) at 140° C. for 45 minutes, and then cooled to between 0° C. or 30° C. at 1° C./min and stabilized (maintain temperature) between 0° C. or 30° C. for 30 minutes. The sample is eluted from the column by pumping the solvent through the column at a flow rate of 1.0 ml/min for 10 minutes at 30° C. The temperature of the column is then ramped to 140° C. at a heating rate of 2° C./min as the solvent flow through the column is maintained at a flow rate of 1.0 ml/min. The concentration of eluting polymer is monitored with an infrared detector.

A commercial preparative TREF instrument (Model MC2, Polymer Char S.A.) is used to fractionate the resin into Chemical Composition Fractions. Approximately 2 g of polymer is placed into a reactor and dissolved in 200 mL of xylene, stabilized with 600 ppm of BHT, at 130° C. for approximately 60 minutes. The mixture is allowed to equilibrate for 45 minutes at 90° C., and then cooled to either 30° C. (standard procedure) or 15° C. (cryo procedure) using a cooling rate of 0.1° C./min. The temperature of the cooled mixture is increased until it is within the lowest Isolation Temperature Range to be used (see Table 2) and the mixture is heated to maintain its temperature within the specified range for 20 minutes. The mixture is sequentially filtered through a 75 micron column filter and then a 2 micron disk filter using 10 psi to 50 psi of pressurized nitrogen. The reactor is washed twice with 50 ml of xylene heated to maintain the temperature of the wash mixture within the designated temperature range and held at that temperature for 20 minutes during each wash cycle. The fractionation process is continued by introducing fresh xylene (200 mL of xylene, stabilized with 600 ppm of BHT) into the reactor, increasing the temperature of the mixture until it reaches the next highest Isolation Temperature Range in the sequence indicated in Table 2 and heating the mixture to maintain its temperature within the specified range for 20 minutes prior to filtering it as described above. The extraction cycle is sequentially repeated in this manner until the mixture has been extracted at all Isolation Temperature Ranges shown in Table 2. The extracts are independently precipitated with methanol to recover the individual polymer fractions.

TABLE 2
Preparative TREF Fractionation Isolation Temperature Ranges

| | |
|---|---|
| Chemical Composition | Isolation |
| Fraction Designation | Temperature |

| Cryo Procedure | Standard Procedure | Range (° C.) |
|---|---|---|
| 1 | — | 0 to 15 |
| 2 | 1 | 15 to 36* |
| 3 | 2 | 36 to 51 |
| 4 | 3 | 51 to 59 |
| 5 | 4 | 59 to 65 |
| 6 | 5 | 65 to 71 |
| 7 | 6 | 71 to 77 |
| 8 | 7 | 77 to 83 |
| 9 | 8 | 83 to 87 |
| 10 | 9 | 87 to 91 |
| 11 | 10 | Greater than 91 |

*The Isolation Temperature Range for the Standard Procedure is 0 to 36° C.

Dynamic Direct Extraction is used to fractionate the resin into Molecular Weight Fractions, as described in W. Holtrup, Makromol. Chem., 178, 2335 (1977). In such cases, a solution of 1 g of polymer dissolved in 72 mL of hot (120 to 130° C.) xylene, stabilized with 2 g of 2,6-di-tert-butyl-4-methyl phenol per 4 l of xylene, for 1.5 hour within a commercial Preparative TREF instrument (Model MC2, Polymer Char S.A.), is treated with 108 mL of non-solvent (diethylene glycol monobutyl ether, DEGME) for 30 min at a temperature of 120° C., before being filter. The polymer is precipitated from the filtrate using excess methanol. The fractionation process is repeated by extracting the gel phase left in the reactor using the volumetric ratios of xylenes/DEGME mixtures described in Table 3. In all these extractions, except the last, the indicated amount of xylene is added to the gel phase and the mixture heated between 120 to 130° C. for an hour before adding the DEGME and heating the mixture at 120° for 30 minutes prior to filtering the mixture and precipitating the polymer fraction using excess methanol. The last fractionation is conducted using Xylene alone.

TABLE 3
Volumetric ratios of xylenes/DEGME mixtures used in Dynamic Direct
Extraction

| Solvent | |
|---|---|
| Xylene | DEGME |

| Fraction | Volume (ml) | Volume (ml) | Percent |
|---|---|---|---|
| 1 | 72.0 | 108.0 | 60.0 |
| 2 | 84.6 | 95.4 | 53.0 |
| 3 | 91.8 | 88.2 | 49.0 |
| 4 | 95.4 | 84.6 | 47.0 |
| 5 | 100.3 | 79.7 | 44.3 |
| 6 | 102.6 | 77.4 | 43.0 |
| 7 | 103.7 | 76.3 | 42.4 |
| 8 | 104.6 | 75.4 | 41.9 |
| 9 | 105.7 | 74.3 | 41.3 |
| 10 | 180 | 0 | 0 |

Melt index and high load melt index are determined according to ASTM 1238 (190° C., 2.16 or 21.6 kg, respectively). In the event a weight is not specified as part of a melt index, it is assumed that 2.16 kg was used. Density is determined using chips cut from plaques compression molded in accordance with ASTM D-4703-07 and aged for 40 hrs at 23° C. plus or minus 2° C. and measured as specified by ASTM D-1505, unless otherwise stated. Tensile Strength is determined according to ASTM D-882. 1% Secant Modulus (machine direction (MD) and transverse direction (TD)) is determined according to by ASTM D-882. Dart Impact is determined according to ASTM D-1709, method A. Elmendorf Tear (MD and TD) is determined according to ASTM D-1922. Peak Melting Point (Tm) is determined by DSC as described below. Dart Drop Impact is determined according to ASTM D-1709, method A.

The ¹³C NMR spectroscopic analysis is conducted as follows: Polymer samples for ¹³C NMR spectroscopy are dissolved in d₂-1,1,2,2-tetrachloroethane at concentrations between 10-15 wt % prior to being inserted into the spectrometer magnet. ¹³C NMR data is collected at 120° C. in a 10 mm probe using a Varian spectrometer with a ¹Hydrogen frequency of 700 MHz. A 90 degree pulse, an acquisition time adjusted to give a digital resolution between 0.1 and 0.12 Hz, at least a 10 second pulse acquisition delay time with continuous broadband proton decoupling using swept square wave modulation without gating is employed during the entire acquisition period. The spectra is acquired using time averaging to provide a signal to noise level adequate to measure the signals of interest. ¹³C NMR Chemical Shift Assignments and calculations involved in characterizing polymers are made as outlined in the work of M. R. Seger and G. Maciel, “Quantitative ¹³C NMR Analysis of Sequence Distributions in Poly(ethylene-co-1-hexene)”, Anal. Chem., 76, 5734-5747 (2004). Triad concentrations are determined by spectral integration and normalized to give the mole fraction of each triad: ethylene-ethylene-ethylene (EEE), ethylene-ethylene-hexene (EEH), ethylene-hexene-ethylene (EHE), hexene-ethylene-ethylene (HEE), hexene-ethylene-hexene (HEH), hexene-hexene-hexene (HHH). The observed triad concentrations are converted into the following diad concentrations: ethylene-ethylene (EE), hexene-hexene (HH) and ethylene-hexene (EH). The diad concentrations are then used to establish r₁r₂ as follows:

$${r}_{1} {r}_{2} = 4 * \frac{EE * HH}{{( EH )}^{2}}$$

Mole percent 1-hexene (Mol % comonomer) is determined as follows:

Mole Percent Hexene=(HHH+HHE+EHE)*100

Run Number is determined as follows:

$$Run Number = ( HEH + \frac{1}{2} * HEE ) * 100$$

Average ethylene run length is calculated by dividing the comonomer content by the run number. Average Ethylene Run Length=(HEH+EEH+EEE)/(run number). “Butyls” per 1000 carbons is calculated by dividing the 1-hexene-centered triads by the sum of twice the ethylene-centered triads plus six times the 1-hexene-centered triads and the resultant quotient multiplying by 1000.

$$Buty ls per 1000 Carbons = \frac{HHH + HHE + EHE}{\begin{matrix}6 * ( HHH + HHE + EHE ) + \\ 2 ( HEH + EEH + EEE )\end{matrix}} * 1000$$

Proton (¹H) NMR data is collected at 120° C. in a 5 mm probe using a Varian Spectrometer with a ¹Hydrogen frequency of at least 400 MHz. The data is recorded using a maximum pulse width of 45 degrees, 8 seconds between pulses and signal averaging 120 transients.

The hot tack initiation temperature of film is the temperature to which the film must be heated before it undergoes useful bonding to itself under pressure. Relatively lower hot tack initiation temperatures are desirable in commercial heat sealing equipment, as the lower temperatures provide for higher production rates of the packages on the equipment. Hot tack initiation temperature is defined as the minimum temperature required to develop measurable strength (0.5 N/cm or higher) of a seal immediately after being made, and prior to being cooled and aged.

The hot tack initiation temperature of film is determined using a laboratory tester such as a J & B Instrument's Hot Tack instrument as follows: The free ends of a 15 mm inch wide sample of film cut to the appropriate length is fit into the jaws of the hot tack instrument. The hot tack tester is operated using a dwell time of about 0.5 second and a sealing pressure of 0.50 N/mm². The hot seal is cooled for 0.4 seconds and then the jaws of the instrument are separated at 200 mm/sec strain rate until the seal fails. The peak load at which the seal breaks is measured. The hot tack strength is calculated by dividing the peak load by the sample width. The hot tack strength values for the films are normalized for the film's thickness. The hot tack initiation temperature is determined by measuring the hot tack strength of film samples sealed at various temperatures and then extrapolating from a plot of seal strength versus temperature to find the lowest temperature at which 0.5 N/cm of hot tack strength is present. This same plot is also be used to determine the hot tack plateau and hot tack plateau on-set temperature. The hot tack plateau is the hot tack strength that remains relatively constant. The hot tack plateau on-set temperature is the lowest temperature at which the hot tack plateau begins. In addition, the plateau on-set temperature represents the temperature at which tearing failure mode occurs.

In a preferred embodiment, the polymers used herein have good hot tack strength, hot tack initiation temperature, hot tack plateau, and hot tack plateau on-set temperature. The polymers of this invention generally have a hot tack initiation temperature less than about 110° C., alternately less than about 90° C., alternately less than about 80° C., alternately less than about 60° C., alternately less than 50° C. In a preferred embodiment the polymers (and films thereof) used herein have a hot tack strength of 2 N/15 mm or more, preferably 3 N/15 mm or more, preferably 4 N/15 mm or more, preferably 6 N/15 mm or more. In another embodiment, the polymers (and films thereof) used herein have a hot tack plateau of at least 1° C., preferably of at least 15° C., preferably of at least 20° C. wide.

The heat seal initiation temperature is the temperature to which the polymer must be heated before it will undergo useful bonding to itself under pressure. Relatively lower heat seal initiation temperatures are desirable in commercial heat sealing equipment, as the lower temperatures provide for higher production rates of the packages on the equipment. Heat seal initiation temperature is defined as the minimum temperature required to develop measurable strength (0.5N/cm or higher) of a heat seal after it has been cooled and aged for at least one day. The heat seal of a film is determined using a laboratory tester such as a Theller Model PC Heatseal as follows. A sample of film is cut so that its length exceeds the length of the Theller Model PC Heatseal's seal bar. The sample is sandwiched between to sheets of Mylar™ film and placed between the platens of the Theller Model PC Heatseal instrument. The sealer is operated using a dwell time of about one second and a sealing pressure of 50 N/cm² for making the seals. Seals are made in the transverse direction of the film and the heat sealing anvils are insulated from the film being sealed by a Mylar™ film. The seals are aged for 24 hours before being tested for strength. For the strength tests, sealed samples are cut into 1.27 cm (0.5 inch) wide pieces and then strength tested using an Instron instrument at a crosshead speed of 508 mm/min (20 inches/min) and a 5.08 cm (2 inch) jaw separation. The ends of the samples are fixed in the jaws of the Instron instrument, and then the jaws are separated at the strain rate until the seal fails. The peak load at which the seal breaks is measured and the seal strength is calculated by dividing the peak load by the sample width. The seal strength values for the films are normalized for the film's thickness. The heat seal initiation temperature is determined by measuring the seal strength of samples sealed at various temperatures and then extrapolating from a plot of seal strength versus temperature to find the lowest temperature at which 0.5 N/cm of seal strength is present. This same plot is also be used to determine the heat seal plateau and heat seal plateau on-set temperature. The heat seal plateau is the seal strength that remains relatively constant. The heat seal plateau on-set temperature is the lowest temperature at which the heat seal plateau begins. In addition, the plateau on-set temperature represents the temperature at which tearing failure mode occurs.

In a preferred embodiment, the polymers (and films thereof) used herein have good heat seal strength, heat seal initiation temperature, heat seal plateau, and plateau on-set temperature. The polymers of this invention generally has a heat seal initiation temperature less than about 110° C., alternately less than about 90° C., alternately less than about 80° C., alternately less than about 60° C., alternately less than 50° C. The polymers used herein (and films thereof) have a heat seal strength of 1 N/15 mm or more, preferably 2 N/15 mm or more, preferably 3 N/15 mm or more, preferably 4 N/15 mm or more, preferably 5 N/15 mm or more. Preferably, the polymers used herein (and films thereof) have a heat seal plateau that is no more than 5° C. (preferably no more than 10° C., preferably no more than 15° C., preferably no more than 20° C.) above the heat seal initiation temperature and where the heat seal plateau is at least 10° C. (preferably at least 15° C., preferably at least 20° C.) wide.

In another embodiment, this invention relates to ethylene-based polymer compositions, articles made therefrom, and methods of making the same. Articles prepared from ethylene-based polymer compositions are prepared according to a process window, e.g., at specific extrusion rates/conditions, etc. which provide favorable physical properties. Articles, such as film, prepared according to these techniques exhibit physical properties equivalent to or superior than those made with conventional linear low density polyethylenes prepared with Ziegler-Natta catalyst as well as previous film made with metallocene LLDPE's.

Ethylene-based polymer compositions useful herein are composed of hafnocene catalyzed linear low density polyethylene (LLDPE), which optionally has up to about 25 mole percent of polymer units derived from an alpha-olefin comonomer (preferably hexene). Ethylene-based polymer compositions also include blends of linear low density polyethylene and one or more additional polymers selected from the following: one or more very low density polyethylenes, one or more low density polyethylenes, one or more medium density polyethylenes, one or more high density polyethylenes, one or more differentiated polyethylene, or other conventional polymers.

In a preferred embodiment, the polyethylene useful herein is produced by polymerization of ethylene and, optionally, an alpha-olefin with a catalyst having as a transition metal component a bis(n-C₃₋₄ alkyl cyclopentadienyl) hafnium compound, wherein the transition metal component comprises from about 95 mol % to about 99 mol % of the hafnium compound. Articles made from these ethylene-based polymer compositions prepared according to a specific process window, e.g., at specific extrusion rates/conditions, provide favorable physical properties. For example, films prepared at a blown film extrusion rate of from about 9.2 to about 28.9 Kg/hr/cm die circumference through an annular die of 0.7 mm to 1.1 mm, using blow-up ratio of from about 1 to about 4, frost line heights of from 0.25 m to about 1.02 m have excellent bubble stability and excellent tear strength. Typical articles include multilayer films, such as those prepared by blown, extruded, and/or stretch and/or shrink film manufacturing techniques, and articles made from such films.

This invention also relates to a polyethylene film having an MD 1% Secant Modulus of 220 MPa or more, and an MD Elmendorf Tear of Y g/micron or more, provided that the MD Elmendorf Tear is 11.8 g/micron or more (alternately 19.6 g/micron or more, alternately 23.6 g/micron or more), where Y≧−0.4515(Dart Drop in g/micron)+33.3 g/microns. Preferably, the film has a ratio of Dart Drop Impact (g/micron) to MD Elmendorf Tear (g/micron) of 0.95 or more (preferably 0.95 to 1.15) and/or an MD Elmendorf Tear of 16 g/micron or more (preferably 18 g/micron, preferably 20 g/micron), and/or a TD Elmendorf Tear of 16 g/micron or more (preferably 18 g/micron, preferably 20 g/micron).

This invention relates to a polyethylene films (preferably multilayer polyethylene film having at least three layers) of an ethylene polymer having:

1) melt index of (2.16 kg, 190° C.) 1.0 dg/min or less (alternately 0.80 or less, alternately 0.75 or less),

2) a high load melt index (21.6 kg, 190° C.) of 35 dg/min or less (alternately 30 or less, alternately 25 or less, alternately 22 or less),

3) a density of 0.910 to 0.945 g/cc (preferably from 0.920 to 0.940 g/cc, preferably from 0.921 to 0.935 g/cc, preferably from 0.922 to 0.930 g/cc),

4) an Mw/Mn of greater than 1 to about 5 (preferably 1.5 to about 4, preferably 2 to 4, preferably 2.5 to 4), and

5) at least 5 wt % that is soluble at 60° C. or less in xylene, where the soluble portion has:

i) an Mw (GPC) of 150,000 g/mol or more (preferably 200,000 g/mol or more, preferably 250,000 g/mol or more),

ii) an Mw/Mn of 2 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) a r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more), and

where each of the three layers may be the same or different ethylene polymer; and

wherein the film has:

a) a MD 1% Secant Modulus of 220 MPa or more (preferably 230 MPa or more, preferably 240 MPa or more),

b) a Dart Drop Impact of 19 g/micron or more (preferably 20 g/micron or more, preferably 21 g/micron or more),

c) a MD Elmendorf Tear of 16 g/micron or more (preferably 18 g/micron, preferably 20 g/micron),

d) a thickness of 10 to 50 microns (preferably 15 to 40 microns),

e) a Dart Drop Impact to MD Elmendorf Tear Ratio of 0.95 to 1.15,

f) a MD to TD Elmendorf Tear Ratio of 0.9 or more (preferably 1.0 or more, preferably 1.1 or more, preferably 1.2 or more, preferably 1.3 or more, alternately 1.2 to 1.4),

g) optionally, an MD Elmendorf Tear of Y g/micron, where Y≧−0.4515(Dart Drop in g/micron)+33.3 g/microns, wherein the MD Elmendorf tear is at least 11.8 g/micron (alternately 19.6 g/micron or more, alternately 23.6 g/micron or more), and

h) optionally, a TD Elmendorf Tear of 16 g/micron or more (preferably 18 g/micron, preferably 20 g/micron).

In another embodiment, this invention relates to a process to make a film comprising:

A) selecting an ethylene polymer having:

1) melt index of (2.16 kg, 190° C.) 1.0 dg/min or less (alternately 0.80 or less, alternately 0.75 or less),

2) a high load melt index (21.6 kg, 190° C.) of 35 dg/min or less (alternately 30 or less, alternately 25 or less, alternately 22 or less),

3) a density of 0.910 to 0.945 g/cc (preferably from 0.920 to 0.940 g/cc, preferably from 0.921 to 0.935 g/cc, preferably from 0.922 to 0.930 g/cc),

4) an Mw/Mn of greater than 1 to about 5 (preferably 1.5 to about 4, preferably 2 to 4, preferably 2.5 to 4), and

5) at least 5 wt % that is soluble at 60° C. or less where the soluble portion has:

i) an Mw (GPC) of 150,000 g/mol or more (preferably 200,000 g/mol or more, preferably 250,000 g/mol or more),

ii) an Mw/Mn of 2.0 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) a r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more); and

B) extruding the ethylene polymer through a blown film die:

i) at a stretch rate of 2 sec⁻¹ or more (alternately 2 to 3)(Stretch Rate s−1 equals (V_{f}-V₀)/FLH where V_{f} is the speed of the melt at the frost line height, V₀ is the speed of the melt at the die exit and FLH is the frost line height),

ii) a processing time (die to frost line) of 2 seconds or less (alternately 0.5 to 2 seconds),

iii) a blow up ratio of 2.5 or less (alternately of 1.5 to 2.5),

iv) a frost line height of 1.0 meter or less (preferably 0.8 meters or less, preferably 0.66 meter or less, alternately 0.48 meters or less, preferably 1.0 to 0.1 meter),

v) a die through put rate of 2.0 Kg/hr/cm of die circumference or more (preferably 2.1 Kg/hr/cm of die circumference or more, preferably 2.5 Kg/hr/cm of die circumference or more, preferably 2.9 Kg/hr/cm of die circumference), and

vi) such that three layers of ethylene polymer are formed;

C) obtaining a film having:

a) a MD 1% Secant Modulus of 220 MPa or more (preferably 230 MPa or more, preferably 240 MPa or more),

b) a Dart Drop Impact of 19 g/micron or more (preferably 20 g/micron or more, preferably 21 g/micron or more),

c) a MD Elmendorf Tear of 16 g/micron or more (preferably 18 g/micron, preferably 20 g/micron),

d) a thickness of 10 to 50 microns (preferably 15 to 40 microns),

e) a Dart Drop Impact to MD Elmendorf Tear Ratio of 0.95 to 1.15,

f) MD to TD Elmendorf Tear Ratio of 0.9 or more (preferably 1.0 or more, preferably 1.1 or more, preferably 1.2 or more, preferably 1.3 or more, alternately 1.2 to 1.4),

g) optionally, an MD Elmendorf Tear of Y g/micron, where Y≧−0.4515(Dart Drop in g/micron)+33.3 g/microns, wherein the MD Elmendorf tear is at least 11.8 g/micron (alternately 19.6 g/micron or more, alternately 23.6 g/micron or more), and

h) optionally, a TD Elmendorf Tear of 16 g/micron or more (preferably 18 g/micron, preferably 20 g/micron).

In another embodiment this invention relates to a process to make a film comprising:

A) selecting an ethylene polymer having:

1) melt index of (2.16 kg, 190° C.) 1.0 dg/min or less (alternately 0.80 or less, alternately 0.75 or less),

2) a high load melt index (21.6 kg, 190° C.) of 35 dg/min or less (alternately 30 or less, alternately 25 or less, alternately 22 or less),

3) a density of 0.910 to 0.945 g/cc (preferably from 0.920 to 0.940 g/cc, preferably from 0.921 to 0.935 g/cc, preferably from 0.922 to 0.930 g/cc),

4) a Mw/Mn ratio of greater than 1 to about 5 (preferably 1.5 to about 4, preferably 2 to 4, preferably 2.5 to 4), and

5) at least 0.5 mole % C₃ to C₂₀ comonomer (preferably C₄ to C₁₂ alpha-olefin, preferably butene, hexene and/or octene) as determined by ¹³C NMR, and

6) at least 5 wt % that is soluble at 60° C. or less where the soluble portion has:

i) an Mw (GPC) of 150,000 g/mol or more (preferably 200,000 g/mol or more, preferably 250,000 g/mol or more),

ii) an Mw/Mn of 2 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) a r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more); and

B) dissolving the ethylene polymer into xylene at a temperature of 120° C., cooling the mixture at a rate of 1° C. per minute, and then collecting the fraction of ethylene polymer that is soluble at 60° C. or less, where the soluble portion has:

i) an Mw (GPC) of 150,000 g/mol or more (preferably 200,000 g/mol or more, preferably 250,000 g/mol or more),

ii) an Mw/Mn of 2 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) a r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more);

C) forming the ethylene polymer fraction into a film.

In a preferred embodiment, the portion that is soluble in xylene at 60° C. or less is present in the polymer at 5 wt % or more, preferably 7 wt % or more, preferably at 10 wt % or more, preferably at 20 wt % or more, preferably at 25 wt % or more.

In a preferred embodiment, the film formed from the ethylene polymer portion that is soluble in xylene at 60° C. or less has:

1) an MD Elmendorf Tear of at least 2 g/micron (preferably at a density of about 0.890 g/cc), (alternately of at least 4 g/micron (preferably at a density of about 0.906 g/cc), of at least 5 g/micron (preferably at a density of about 0.915 g/cc); TD Elmendorf Tear of at least 6 g/micron (preferably at a density of about 0.890 g/cc), of at least 13 g/micron (preferably at a density of about 0.906 g/cc), of at least 21 g/micron (preferably at a density of about 0.915 g/cc)),

2) a Dart Drop Impact of at least 10 g/microns, (alternately at least 20 g/microns, alternately at least 30 g/microns),

3) an MD 1% Secant Modulus of at least 42 MPa (preferably at a density of about 0.890 g/cc) (alternately of at least 120 MPa (preferably at a density of about 0.906 g/cc), alternately of at least 214 MPa (preferably at a density of about 0.915 g/cc)), and a TD 1% Secant Modulus of at least 42 MPa (preferably at a density of about 0.890 g/cc) (alternately of at least 124 MPa (preferably at a density of about 0.906 g/cc), alternately of at least 226 MPa (preferably at a density of about 0.915 g/cc)),

4) an MD Tensile at Yield of at least 4 MPa (preferably at a density of about 0.890 g/cc) (alternately of at least 6.5 MPa (preferably at a density of about 0.906 g/cc), alternately of at least 8.5 MPa (preferably at a density of about 0.915 g/cc)), and a TD 1% Tensile at Yield of at least 3 MPa (preferably at a density of about 0.890 g/cc) (alternately of at least 6 MPa (preferably at a density of about 0.906 g/cc), alternately of at least 9 MPa (preferably at a density of about 0.915 g/cc)),

5) a Tm (second melt) of 40 to 140° C., preferably 45 to 100° C., preferably 45 to 90° C., preferably 50 to 90° C., preferably 60 to 90° C., and/or

6) a heat seal plateau of at least 7° C. (preferably at least 9° C., preferably at least 10° C.).

In an alternate embodiment, the ethylene polymer portion that is soluble in xylene at 60° C. or less may be molded into an article of manufacture by such methods as thermoforming, draped thermoforming and twin-sheet thermoforming. Common to all of these thermoforming methods is that a polyethylene sheet (monolayer or multilayer) made in conventional manner and suitable for thermoforming is heated in a thermoforming oven and then formed into a part using one of the typical thermoforming methods as outlined here. In simple thermoforming a heated sheet is placed over a female mold and is draw into the mold by use of vacuum. These techniques can employ Plug, Billowing and Pressure assistance. In draped thermoforming a heated sheet is placed over a male mold and vacuum is applied to draw the sheet onto the mold and take is shape. In twin-sheet thermoforming two heated sheet are sequentially formed to two female molds which are pressed together while the sheets are still molten to form solid seals, knits or welds, which hold the formed sheets together when cooled.

In a preferred embodiment, the molded article formed from the ethylene polymer portion that is soluble in xylene at 60° C. or less has:

1) a MD Tensile Strength (Break of at least 7 MPa, preferably at least 8 MPa, preferably at least 12 MPa, preferably of at least 17 MPa;

2) Elongation (Break of at least 700%, preferably of at least 600%

3) a Flexural Modulus (ASTM D-790) of at least 12 MPa, preferably at least 13 MPa, preferably at least 23 MPa,

4) no breaks when tested according to Notched Izod ASTM D-256 at 23° C. to −40° C.,

5) an Instrumented Impact (ASTM D-3763) Max Energy at 23° C. of at least 14 J, preferably at least 15 J, preferably at least 34 J,

6) an Instrumented Impact (ASTM D-3763) Total Energy at 23° C. of at least 17 J, preferably at least 20 J, preferably at least 53 J,

7) an Instrumented Impact (ASTM D-3763) Max Energy at −40° C. of at least 17 J, preferably at least 16 J, preferably at least 19 J,

8) an Instrumented Impact (ASTM D-3763) Total Energy at −40° C. of at least 28 J, preferably at least 27 J, preferably at least 34 J,

9) a ductile failure mode under Instrumented Impact (ASTM D-3763) at 23° C. to −40° C., and/or

10) a Tear Strength, (Die C ASTM D-624) of at least 35 kN/m, preferably at least 40 kN/m, preferably at least 62 kN/m.

In another embodiment, this invention relates to a process to make a film comprising

A) selecting an ethylene polymer that is soluble in xylene at 60° C. or less, and has:

i) an Mw (GPC) of 150,000 g/mol or more (preferably 200,000 g/mol or more, preferably 250,000 g/mol or more),

ii) an Mw/Mn of 2 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) an r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more); and

B) forming the ethylene polymer into a film.

In another embodiment, this invention relates to an article of manufacture (preferably a film) comprising at least 50 wt % of an ethylene copolymer having:

i) an Mw (GPC) of 150,000 g/mol or more (preferably 200,000 g/mol or more, preferably 250,000 g/mol or more),

ii) an Mw/Mn of 2 or more (alternately 4.0 or more, alternately 5 or more, alternately 6 or more, alternately 7 or more, alternately 8 or more, alternately 9 or more, alternately 10 or more, alternately 15 or more, alternately 20 or more),

iii) at least 5 mol % (preferably at least 6 mol %, preferably at least 7 mol %) comonomer (preferably C₃ to C₂₀, olefin, preferably C₄ to C₁₂ alpha-olefin, preferably hexene, octene, and/or butene) as determined by ¹³C NMR,

iv) a r₁r₂ value of 1.0 or less (preferably less than 0.9, preferably less than 0.8, preferably less than 0.7),

v) “butyls” per 1000 carbons of 15 or more (preferably 20 or more, preferably 25 or more, preferably 30 or more, preferably 35 or more, preferably 40 or more).

In a preferred embodiment the Mw/Mn of the ethylene polymer is at least 1 unit less than the Mw/Mn of the ethylene polymer portions soluble in xylene at 60° C. or less (preferably at least 1.5 units less, preferably at least 2 units less, preferably at least 2.5 units less, preferably at least 3 units less, preferably at least 5 units less, preferably at least 7 units less, preferably at least 10 units less).

### LLDPE Polymers

In a preferred embodiment, the ethylene polymer used herein is an LLDPE (linear low density polyethylene) polymer having a density of 0.910 to 0.945 g/cc (preferably 0.920 to 0.940 g/cc) produced using a hafnium metallocene catalyst as described below.

Suitable catalysts for making LLDPE polymers useful herein include hafnium transition metal metallocene-type catalyst systems for polymerizing one or more olefins represented by the formula:

Cp^{A}Cp^{B}HfXₙ

wherein each X is chemically bonded to Hf, each Cp group is chemically bonded to Hf, and n is 0, 1, 2, 3 or 4. Preferably, n is 1 or 2. The ligands represented by Cp^{A} and Cp^{B} may be the same or different cyclopentadienyl ligands or ligands isolobal to cyclopentadienyl, either or both of which may contain heteroatoms and either or both of which may be substituted by a group R. In one embodiment, Cp^{A} and CP^{B} are independently selected from the group consisting of cyclopentadienyl, indenyl, tetrahydroindenyl, fluorenyl, and substituted derivatives of each.

Independently, each Cp^{A} and Cp^{B} may be unsubstituted or substituted with any one or combination of substituent groups R. Non-limiting examples of substituent groups R include hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof.

Exemplary hafnocene catalyst systems used to produce LLDPEs useful herein are set forth in the description and examples of U.S. Pat. Nos. 6,936,675 and 6,528,597, both of which are fully incorporated herein by reference. Particularly preferred catalysts include bis(n-propyl cyclopentadieneyl) hafnium di-alkyl (preferably methyl, ethyl, or propyl). Additionally useful catalysts include bis(n-propyl cyclopentadieneyl) hafnium di-halide (preferably bromide, chloride or fluoride, alternately preferably chloride or fluoride, preferably fluoride).

The catalyst compounds described herein are typically used in combination with an activator (such as alumoxane or a non-coordinating anion activator (NCA)) with or without a trialkylaluminum scavenger or co-activator (such as triethylaluminum, tri-n-octyl aluminum, tri-isobutylaluminum). The catalyst compound combined with the activator (and optional co-activator) is referred to as a catalyst system. Particularly useful NCA's include N,N-dimethylanilinium tetrakisperfluorophenylborate, triphenylmethyl tetrakisperfluorophenylborate, N,N-dimethylanilinium tetrakisperfluoronapthylborate and the like from U.S. Pat. No. 5,198,401. Further useful activator/catalyst combinations include NCA's and metallocenes on support as described in U.S. Pat. No. 6,040,261, U.S. Pat. No. 5,427,991, U.S. Pat. No. 5,869,723, U.S. Pat. No. 5,643,847, and EP 824,112. The NCAs may also be used in combination with an alumoxane (such as methylalumoxane) on a support before or after the catalyst compound has been placed thereon.

In a preferred embodiment the catalyst and or the activator are supported on an inorganic oxide, such as silica, fumed silica and the like. A preferred silica is one having an average particle size of 10 to 100 microns, preferably 20 to 50, preferably 20 to 35 microns. A useful silica is available from Ineos Silicas, England under the tradename INEOS™ ES757 A preferred combination is MAO/(n-C₃Cp)₂Hf-Q₂ (where Q₂ is di-halide or di-alkyl, preferably methyl, ethyl, propyl, butyl, bromide, chloride or fluoride) on silica, preferably dimethyl on silica (see Ex. 1) or difluoride on silica (see Ex. 2). The silica may be dried or calcined prior to placing the catalyst and or activator on the support.

Further description of useful catalyst systems are found in U.S. Pat. Nos. 6,242,545; 6,248,845; and 6,956,088, and in U.S. Application Publication Nos. 2005/0171283 A1 and 2005/0215716 A1, all of which are fully incorporated herein by reference.

The hafnium transition metal metallocene-type catalyst compounds and catalyst systems presently employed are suited for the polymerization of monomers, and, optionally, one or more comonomers, in any catalytic polymerization process, solution phase, gas phase, or slurry phase. Preferably, a gas or slurry phase process is used. In particular, the process used to polymerize LLDPEs is as described in the specification and examples of U.S. Pat. Nos. 6,936,675 and 6,528,597, which are fully incorporated herein by reference.

In the processes used to manufacture the LLDPEs described herein, the monomer supplied to the polymerization zone is regulated to provide a ratio of ethylene to alpha-olefin comonomer so as to yield a polyethylene having a comonomer content, as a bulk measurement, of from about 0.5 to about 25.0 mole % comonomer. The reaction temperature, monomer residence time, catalyst system component quantities, and molecular weight control agent (such as H₂) may be regulated so as to provide a LLDPE resin having a Mw from about 10,000 to about 500,000 g/mol, and a MWD value of from about 1.0 to about 5. Specifically, comonomer to ethylene concentration or flow rate ratios are commonly used to control resin density. Similarly, hydrogen to ethylene concentrations or flow rate ratios are commonly used to control resin molecular weight. In both cases, higher levels of a modifier results in lower values of the respective resin parameter. Gas concentrations may be measured by, for example, an on-line gas chromatograph or similar apparatus to ensure relatively constant composition of recycle gas streams. One skilled in the art will be able to optimize these modifier ratios and the given reactor conditions to achieve a targeted resin melt index, density, and/or other resin properties. Additionally, the use of a process continuity aid, while not required, may be desirable in any of the foregoing processes. Such continuity aids are well known to persons of skill in the art and include, for example, metal stearates (particularly calcium stearate).

The LLDPEs useful herein may typically have a broad (e.g. less than 20%, alternately less than 16%, alternately between 15 and 20%) composition distribution as measured by Composition Distribution Breadth Index (CDBI). The polymers useful herein may have a CDBI less than 40%, alternately less than 30%, alternately between 10% and 40%. In an alternate embodiment, the polymers useful herein may have a CDBI of from 1 to 40.

In one aspect, the polymers have a density in the range of from 0.910 g/cc to 0.945 g/cm³, preferably in the range of from 0.920 g/cm³ to 0.940 g/cm³, more preferably in the range of from 0.920 g/cm³ to 0.935 g/cm³.

The LLDPEs useful herein typically have a Mw of from about 10,000 to 500,000 g/mol, preferably 10,000 to about 250,000 g/mol. Preferably, the Mw is from about 20,000 to about 200,000 g/mol, or from about 25,000 to about 150,000 g/mol.

In a preferred embodiment, polymers useful herein have an M_{w}/Mₙ of from about 1.5 to about 5, particularly from about 2.0 to about 4.0, preferably from about 3.0 to about 4.0 or from about 2.5 to about 4.0.

In one embodiment, the polymers have a melt index ratio (I_{21.6}/I_{2.16}) of from about 10 to about 50. The polymers, in a preferred embodiment, have a melt index ratio of from about 15 to about 45, more preferably from about 20 to about 40.

In some embodiments, the LLDPE polymers exhibit a Tm as measured by differential scanning calorimetry (“DSC”) of from about 90° C. to about 130° C. Tm is determined as follows: Samples weighing approximately 5-10 mg are sealed in aluminum sample pans. The DSC data is recorded by first cooling the sample to −50° C. and then gradually heating it to 200° C. at a rate of 10° C./minute. The sample is kept at 200° C. for 5 minutes before a second cooling-heating cycle is applied. Both the first and second cycle thermal events are recorded. The melting temperature is measured and reported during the second heating cycle (or second melt). Prior to the DSC measurement, the sample is aged (typically by holding it at ambient temperature for a period up to about 5 days) or annealed to maximize the level of crystallinity.

In another embodiment, the LLDPE's may contain less than 5 ppm hafnium, generally less than 2 ppm hafnium, preferably less than 1.5 ppm hafnium, more preferably less than 1 ppm hafnium. In an embodiment, the polymer contains in the range of from about 0.01 ppm to about 2 ppm hafnium, preferably in the range of from about 0.01 ppm to about 1.5 ppm hafnium, more preferably in the range of from about 0.01 ppm to 1 or less ppm hafnium, as determined using ICPES (Inductively Coupled Plasma Emission Spectrometry) as follows. a sample is introduced into a plasma where it is atomized and the atoms ionized, the electrons in the atoms are excited to specified higher energy levels. When the electrons return to their ground state(s), they emit wavelengths of radiation characteristic of each element. The elements present in a sample are determined by monitoring the wavelengths of the emitted radiation. The amount of each atom present is determined from the intensities of the wavelengths by comparison to those generated by known standards.

In one embodiment, the polymer useful herein is a linear low-density polyethylene resin produced by polymerization of ethylene and, optionally, an alpha-olefin comonomer having from 3 to 20 carbon atoms, preferably 1-hexene. The ethylene-based polymers may have up to about 25 mole % alpha-olefin comonomer incorporated into the copolymer, preferably form 0.5 to 15 mole %, preferably from 0.5 to 4.0 mol %.

### Blends

In another embodiment, the polyethylene described herein is combined with one or more additional polymers prior to being formed into a film. Useful other polymers include isotactic polypropylene, highly isotactic polypropylene, syndiotactic polypropylene, random copolymer of propylene and ethylene and/or butene and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols and/or polyisobutylene.

In alternate embodiments elastomers are blended with the LLDPE to form rubber toughened compositions that are typically formed into films or molded parts. In a particularly preferred embodiment the rubber toughened composition is a two (or more) phase system where the elastomer is a discontinuous phase and the polymer produced by this invention is a continuous phase. This blend may be combined with tackifiers and/or other additives as described herein.

In a preferred embodiment the polyethylene (made from the hafnocene) is present in the above blends, at from 10 to 99 wt %, based upon the weight of the polymers in the blend, preferably 20 to 95 wt %, even more preferably at least 30 to 90 wt %, even more preferably at least 40 to 90 wt %, even more preferably at least 50 to 90 wt %, even more preferably at least 60 to 90 wt %, even more preferably at least 70 to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGANOX™ 168 available from Ciba-Geigy); anti-cling additives; tackifiers, such as polybutenes, terpene resins, aliphatic and aromatic hydrocarbon resins, alkali metal and glycerol stearates and hydrogenated rosins; UV stabilizers; heat stabilizers; anti-blocking agents; release agents; anti-static agents; pigments; colorants; dyes; waxes; silica; fillers; talc and the like.

### End-Use Applications

Specifically, any of the foregoing polyethylenes or blends thereof may be used in a variety of end-use applications. Such applications include, for example, mono- or multi-layer blown, extruded, and/or shrink films. These films may be formed by any number of well known extrusion or coextrusion techniques such as a blown bubble film processing technique wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15 preferably 7 to 9. However, in another embodiment the film is oriented to the same extent in both the MD and TD directions.

In another embodiment, the layer comprising the polymer composition of this invention (and/or blends thereof) may be combined with one or more other layers. The other layer(s) may be any layer typically included in multilayer film structures. For example the other layer or layers may be: 1) Polyolefins: Preferred polyolefins include homopolymers or copolymers of C2 to C40 olefins, preferably C2 to C20 olefins, preferably a copolymer of an alpha-olefin and another olefin or alpha-olefin (ethylene is defined to be an alpha-olefin for purposes of this invention). Preferably homopolyethylene, homopolypropylene, propylene copolymerized with ethylene and or butene, ethylene copolymerized with one or more of propylene, butene or hexene, and optional dienes. Preferred examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics. 2) Polar polymers: Preferred polar polymers include homopolymers and copolymers of esters, amides, acetates, anhydrides, copolymers of a C2 to C20 olefin, such as ethylene and/or propylene and/or butene with one or more polar monomers such as acetates, anhydrides, esters, alcohol, and or acrylics. Preferred examples include polyesters, polyamides, ethylene vinyl acetate copolymers, and polyvinyl chloride. 3) Cationic polymers: Preferred cationic polymers include polymers or copolymers of geminally disubstituted olefins, alpha-heteroatom olefins and/or styrenic monomers. Preferred geminally disubstituted olefins include isobutylene, isopentene, isoheptene, isohexane, isooctene, isodecene, and isododecene. Preferred alpha-heteroatom olefins include vinyl ether and vinyl carbazole, preferred styrenic monomers include styrene, alkyl styrene, para-alkyl styrene, alpha-methyl styrene, chloro-styrene, and bromo-para-methyl styrene. Preferred examples of cationic polymers include butyl rubber, isobutylene copolymerized with para methyl styrene, polystyrene, and poly-alpha-methyl styrene. 4) Miscellaneous: Other useful layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbonded fibers, and non-wovens (particularly polypropylene spun bonded fibers or non-wovens), and substrates coated with inks, dyes, pigments, PVDC and the like.

The films may vary in thickness depending on the intended application, however films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment or microwave. In a preferred embodiment one or both of the surface layers is modified by corona treatment.

The films described herein may also comprise from 5 to 60 wt %, based upon the weight of the polymer and the resin, of a hydrocarbon resin. The resin may be combined with the polymer of the outer (such as seal) layer(s) or may be combined with the polymer in the core layer(s).

The films described above may be used as stretch and/or cling films with or without common tackifying additives (such as polybutenes, terpene resins, alkali metal stearates and hydrogenated rosins and rosin esters) and or modification by well-known physical processes (such as corona discharge). Stretch/clings films may comprise a slip layer comprising any suitable polyolefin or combination of polyolefins such as polyethylene, polypropylene, copolymers of ethylene and propylene, and polymers obtained from ethylene and/or propylene copolymerized with minor amounts of other olefins, particularly C4 to C12 olefins. Particularly preferred are polypropylene and linear low density polyethylene (LLDPE).

Multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition.

When used in multilayer films, the LLDPE polymer blends are typically used in at least three layers and may be used in any layer of the film, as desired. When more than one layer of the film is formed of a LLDPE polymer blend, each such layer can be individually formulated; i.e., the layers formed of the LLDPE polymer blend can be the same or different chemical composition, density, melt index, thickness, etc., depending upon the desired properties of the film.

To facilitate discussion of different film structures, the following notation is used herein. Each layer of a film is denoted “A” or “B”, where “A” indicates a conventional film layer as defined below, and “B” indicates a film layer formed of any of the LLDPE polymers or blends. Where a film includes more than one A layer or more than one B layer, one or more prime symbols (′, ″, ′″, etc.) are appended to the A or B symbol to indicate layers of the same type (conventional or inventive) that can be the same or can differ in one or more properties, such as chemical composition, density, melt index, thickness, etc. Finally, the symbols for adjacent layers are separated by a slash (/). Using this notation, a three-layer film having an inner layer of a LLDPE polymer blend disposed between two outer, conventional film layers would be denoted A/B/A′. Similarly, a five-layer film of alternating conventional/inventive layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film. The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20.

For the various films described herein, the “A” layer can be formed of any material known in the art for use in multilayer films or in film-coated products. Thus, for example, each A layer can be formed of a polyethylene homopolymer or copolymer, and the polyethylene can be, for example, a VLDPE, a LDPE, a LLDPE, a MDPE, a HDPE, or a DPE, as well as other polyethylenes known in the art. The polyethylene can be produced by any suitable process, including metallocene-catalyzed processes and Ziegler-Natta catalyzed processes. Further, each A layer can be a blend of two or more such polyethylenes, and can include additives known in the art. Further, one skilled in the art will understand that the layers of a multilayer film must have the appropriate viscosity match.

In multilayer structures, one or more A layers can also be an adhesion-promoting tie layer, such as PRIMACOR™ ethylene-acrylic acid copolymers available from The Dow Chemical Company, and/or ethylene-vinyl acetate copolymers. Other materials for A layers can be, for example, foil, nylon, ethylene-vinyl alcohol copolymers, polyvinylidene chloride, polyethylene terephthalate, oriented polypropylene, ethylene-vinyl acetate copolymers, ethylene-acrylic acid copolymers, ethylene-methacrylic acid copolymers, graft modified polymers, and paper.

The “B” layer is formed of a LLDPE polymer or blend, and can be any of such blends described herein. In one embodiment, the B layer is formed of a blend of (a) from 0.1 to 99.9 wt % of a first polymer selected from the group consisting of very low density polyethylene, medium density polyethylene, differentiated polyethylene, and combinations thereof, and (b) from 99.9 to 0.1 wt % of a second polymer comprising a LLDPE polymer or copolymer produced by gas-phase polymerization of ethylene and, optionally, an alpha-olefin with a catalyst having as a transition metal component a bis(n-C₃₋₄ alkyl cyclopentadienyl)hafnium compound, wherein the transition metal component comprises from about 95 to about 99 mole % of the hafnium compound. The copolymer of (b) is preferably characterized by a comonomer content of up to about 5 mole %, a melt index I_{2.16} of from about 0.1 to about 300 g/10 min, a melt index ratio of from about 15 to about 45, a weight average molecular weight of from about 20,000 to about 200,000, a molecular weight distribution of from about 2.0 to about 4.5, and a M_{z}/M_{w} ratio of from about 1.7 to about 3.5. In preferred embodiments, the polymer of (a) is different from the polymer of (b).

The thickness of each layer of the film, and of the overall film, is not particularly limited, but is determined according to the desired properties of the film. Typical film layers have a thickness of from about 1 to about 1000 μm, more typically from about 5 to about 100 μm, and typical films have an overall thickness of from about 10 to about 100 μm.

In further applications, microlayer technology may be used to produce films with a large number of thinner layers. For example, microlayer technology may be used to obtain films having, for example, 24, 50, or 100 layers, in which the thickness of an individual layer is less than 1 μm. Individual layer thicknesses for these films may be less than 0.5 μm, less than 0.25 μm, or even less than 0.1 μm.

In other embodiments, using the nomenclature described above, multilayer films have any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″″; and similar structures for films having six, seven, eight, nine, twenty-four, forty-eight, sixty-four, one hundred, or any other number of layers. It should be appreciated that films having still more layers can be formed using the LLDPE polymers or blends, and such films are within the scope of the invention.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films composed of LLDPE polymer blends can also be used as coatings; e.g., films formed of the inventive polymers or polymer blends, or multilayer films including one or more layers formed of the inventive polymers or polymer blends, can be coated onto a substrate such as paper, metal, glass, plastic and other materials capable of accepting a coating. Such coated structures are also within the scope of the present invention.

In one embodiment, films are composed of one or more LLDPE polymers that exhibit a melt index ratio of from about 20 to about 40, an M_{w}/Mₙ of from about 3.0 to about 4.0, an M_{z}/M_{w} of from about 2.2 to about 3.0, a Tm of from about 119 to about 123° C., and a CDBI of from about 10 to 40. Blown films having these characteristics are preferred. When normalized to 25 micron in thickness, films of these embodiments preferably exhibit a Dart Drop Impact of from about 200 to about 1200, an Elmendorf Tear MD of from about 200 to about 1000, an Elmendorf Tear TD of from about 400 to about 1000. More preferably these films exhibit, a 1% Secant Modulus MD of from about 174.5 to about 244.3 MPa, a 1% Secant Modulus TD of from about 174.5 to about 244.3 MPa, a Tensile MD of from about 41.9 to about 62.8 MPa, and a Tensile TD of from about 34.9 to about 55.8 MPa.

In another aspect, provided are any polymer products containing the LLDPE polymer or polymer blend compositions produced by methods known in the art. In addition, also included are products having other specific end-uses, such as film-based products, which include stretch films, shrink films, bags (i.e., shipping sacks, trash bags and liners, industrial liners, and produce bags), flexible and food packaging (e.g., fresh cut produce packaging, frozen food packaging), personal care films, pouches, medical film products, diaper back sheets and house wrap. Products may also include packaging, for example by bundling, packaging and unitizing a variety of products. Applications for such packaging include various foodstuffs, rolls of carpet, liquid containers and various like goods normally containerized and/or palletized for shipping, storage, and/or display.

In some embodiments, stretch cling films may be formed from the LLDPE polymers and polymer blends described herein. The stretch cling films may be monolayer or multilayer, with one or more layers comprising the LLDPE polymers or blends. In some embodiments, the films may be coextruded, comprising one or more layers made from the LLDPE polymers or blends described herein, along with one or more layers of traditional Ziegler-Natta or metallocene-catalyzed LLDPE, which may, optionally, include a comonomer such as, for example, hexene or octene.

Some resins and blends described herein may also be suited for use in stretch hand wrap films. Stretch film hand wrap requires a combination of excellent film toughness, especially puncture and dart drop performance, and a very stiff, i.e., difficult to stretch, film. This film ‘stiffness’ is required to optimize the stretch required to provide adequate load holding force to a wrapped load and to prevent further stretching of the film. The film toughness is required because hand wrap loads (being wrapped) are typically more irregular and frequently contain greater puncture requirements than typical machine stretch loads. In some embodiments, the films may be down gauged stretch hand wrap films. In further embodiments, LLDPE resins and blends may be blended with LDPE, other LLDPEs, or other polymers to obtain a material with characteristics suitable for use in stretch hand wrap films.

Further product applications may also include surface protection applications, with or without stretching, such as in the temporary protection of surfaces during manufacturing, transportation, etc. There are many potential applications of articles and films produced from the polymer blend compositions described herein.

The LLDPE resins and blends prepared as described herein are also suited for the manufacture of blown film in a high-stalk extrusion process. In this process, a polyethylene melt is fed through a gap (typically 1 to 1.6 mm) in an annular die attached to an extruder and forms a tube of molten polymer which is moved vertically upward. The initial diameter of the molten tube is approximately the same as that of the annular die. Pressurized air is fed to the interior of the tube to maintain a constant air volume inside the bubble. This air pressure results in a rapid 3-to-9-fold increase of the tube diameter which occurs at a height of approximately 5 to 10 times the die diameter above the exit point of the tube from the die. The increase in the tube diameter is accompanied by a reduction of its wall thickness to a final value ranging from approximately 12.7 to 50 microns and by a development of biaxial orientation in the melt. The expanded molten tube is rapidly cooled (which induces crystallization of the polymer), collapsed between a pair of nip rolls and wound onto a film roll.

Two factors are useful to determine the suitability of a particular polyethylene resin or blend for high stalk extrusion: the maximum attainable rate of film manufacture and mechanical properties of the formed film. Adequate processing stability is desired at, for example, throughput rates of up to 2.7 Kg/hr/cm die and high line speeds (>61 m/min) for thin gauge manufacture on modern extrusion equipment. Persons of skill in the art will recognize that varying throughput rates and line speeds may be used without departing from the spirit of the present invention, and that the figures given herein are intended for illustrative purposes only. The resins and blends produced as described herein have molecular characteristics which allow them to be processed successfully at these high speeds. Mechanical strength of the film is different in two film directions, along the film roll (machine direction, MD) and in the perpendicular direction (transverse direction, TD). Typically, the TD strength in such films is significantly higher than their MD strength. The films manufactured from the resins prepared in the process of this invention with the catalysts described herein have a favorable balance of the MD and TD strengths.

Films composed of LLDPE polymers or blends thereof show improved performance and mechanical properties when compared to films previously known in the art. For example, films containing the LLDPE polymers and blends described herein have improved seal strength and hot tack performance, increased toughness, and lower reblock. The films also have a good balance of stiffness vs. toughness as indicated by machine direction tear strength, 1% Secant Modulus, and Dart Impact performance. In addition, such films may also exhibit higher ultimate stretch and have better processability when compared with other LLDPE resins and blends.

In another embodiment, when normalized to 25 micron film thickness, films prepared herein preferably exhibit a Dart Drop Impact of from about 200 to about 1500 grams, an Elmendorf Tear MD of from about 200 to about 1000 g, an Elmendorf Tear TD of from about 300 to about 1000 g. More preferably these films exhibit, a 1% Secant Modulus MD of from about 130.6 to about 314.1 MPa, a 1% Secant Modulus TD of from about 130.6 to about 383.9 MPa, a Tensile MD of from about 34.9 to about 97.7 MPa, and a Tensile TD of from about 17.5 to about 69.8 MPa.

In another embodiment this invention relates to:

1. A polyethylene film having a MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron.

2. The film of paragraph 1 wherein Y is 19.6 g/micron or more, preferably 23.6 g/micron or more.

3. The film of paragraph 1 or 2 wherein the ratio of Dart Impact (g/micron) to MD Elmendorf Tear Ratio (g/micron) is 0.95 or more.

4. The film of paragraph 1, 2 or 3 wherein the MD Elmendorf Tear is 16 g/micron or more.

5. The film of paragraph 1, 2, 3 or 4 wherein the TD Elmendorf Tear is 16 g/micron or more.

6. A multilayer polyethylene film having at least three layers of an ethylene polymer, the ethylene polymer having: 1) melt index of (2.16 kg, 190° C.) 0.75 dg/min or less, 1.0 or less dg/min; 2) a high load melt index (21.6 kg, 190° C.) of 35 dg/min or less, 3) density of 0.910 to 0.945 g/cc, 4) an Mw/Mn of greater than 1 to 5, and 5) at least 5 wt % that is soluble in xylene at 60° C. or less where the soluble portion has: i) an Mw (GPC) of 150,000 g/mole more, ii) an Mw/Mn of 2 or more, preferably 4.0 or more, iii) at least 5 mol % comonomer, iv) an r₁r₂ value of less than 1.0, v) “butyls” per 1000 carbons of 15 or more; and

where each of the three layers may be the same or different ethylene polymer; and

wherein the film has: a) a MD 1% Secant Modulus of 220 MPa or more, b) a Dart Impact of 19 g/micron or more, c) a MD Elmendorf Tear of 16 g/micron or more, d) a thickness of 15 to 50 microns, e) a Dart Impact to MD Elmendorf Tear Ratio of 0.95 to 1.15, f) a MD to TD Elmendorf Tear Ratio of 0.9 or more.

7. The film of paragraph 6 wherein the film has an MD Elmendorf Tear of Y g/micron, where Y≧−0.4515(Dart Drop in g/micron)+33.3 g/microns, wherein the MD Elmendorf tear is at least 11.8 g/micron.

8. The film of paragraph 6 or 7 wherein the ethylene polymer is a copolymer of ethylene and one or more of butene, hexene and octene having a density of 0.920 to 0.940 g/cc.

9. A process to make a film (preferably the film of paragraph 1, 2, 3, 4, 5, 6, 7, or 8) comprising: A) selecting an ethylene polymer having: 1) melt index of (2.16 kg, 190° C.) 0.75 dg/min or less, 2) a high load melt index (21.6 kg, 190° C.) of 25 dg/min or less, 3) density of 0.910 to 0.945 g/cc, 4) an Mw/Mn of greater than 1 to 5, and 5) at least 5 wt % that is soluble in xylene at 60° C. or less, where the soluble portion has: i) an Mw of 150,000 g/mol or more, ii) an Mw/Mn of 2 or more, preferably 4.0 or more, iii) at least 5 mol % comonomer, iv) an r₁r₂ value of less than 1.0, v) “butyls” per 1000 carbons of 15 or more; and B) extruding the ethylene polymer through a blown film die: i) at a stretch rate of 2 sec⁻¹ or more, ii) a processing time (die to frost line) of 2 seconds or less, iii) a blow up ratio of 2.5 (alternately from 1 to 2.5) or less, iv) a frost line height of 0.5 meters (alternately from 0.05 to 0.5 meters) or less, v) a die through put rate of 12.7 Kg/hr/cm of die or more, and vi) such that three layers of ethylene polymer are formed; C) obtaining a film having: a) a MD 1% Secant Modulus of 220 MPa or more, b) a Dart Impact of 19 g/micron or more, c) a MD Elmendorf Tear of 16 g/micron or more, d) a thickness of 15 to 50 microns, e) a Dart Impact to MD Elmendorf Tear Ratio of 0.95 to 1.15, f) a MD to TD Elmendorf Tear Ratio of 0.9 or more.

10. The process of paragraph 9 wherein the film has an MD Elmendorf Tear of Y g/micron, where Y≧−0.4515(Dart Drop in g/micron)+33.3 g/microns, wherein the MD Elmendorf tear is at least 11.8 g/micron.

11. The process of paragraph 9 or 10 wherein the ethylene polymer is a copolymer of ethylene and one or more of butene, hexene and octene having a density of 0.920 to 0.940 g/cc.

12. A process to make a film comprising: A) selecting an ethylene polymer having: 1) melt index of (2.16 kg, 190° C.) 0.75 dg/min or less, 2) a high load melt index (21.6 kg, 190° C.) of 25 dg/min or less, 3) density of 0.910 to 0.945 g/cc, 4) an Mw/Mn of greater than 1 to 5, 5) and from 0.5 to 25 mol % comonomer, and 6) at least 5 wt % that is soluble in xylene at 60° C. or less where the soluble portion has: i) an Mw of 150,000 g/mol or more, ii) an Mw/Mn of 2 or more, preferably 4.0 or more, iii) at least 5 mol % comonomer, iv) a r₁r₂ value of less than 1.0, v) “butyls” per 1000 carbons of 15 or more; and B) dissolving the ethylene polymer into xylene at a temp of 120° C., cooling at a rate of 1° C. per minute, and then collecting the portion of ethylene polymer that is soluble in xylene at 60° C. or less where the soluble portion has: i) an Mw of 150,000 g/mol or more, ii) an Mw/Mn of 2 or more, preferably 4.0 or more, iii) at least 5 mol % comonomer, iv) a r₁r₂ value of less than 1.0, v) “butyls” per 1000 carbons of 15 or more; and C) forming the soluble portion into a film.

13. The process of paragraph 12 wherein the soluble portion comprises at least 5 mole % hexene.

14. The process of paragraph 12 or 13 wherein the film has an MD Elmendorf Tear of Y g/micron, where Y≧−0.4515(Dart Drop in g/micron)+33.3 g/microns, wherein the MD Elmendorf tear is at least 11.8 g/micron.

15. The process of paragraph 12, 13 or 14 wherein the ethylene polymer is a copolymer of ethylene and one or more of butene, hexene and octene having a density of 0.920 to 0.940 g/cc.

16. The process of paragraph 12, 13, 14, or 15 wherein the Mw/Mn of the polymer is at least one unit less than the Mw/Mn of the soluble portion.

17. The process of paragraph 12, 13, 14, 15 or 16 wherein the film has an MD Elmendorf Tear of Y g/micron, where Y≧−0.4515(Dart Drop in g/micron)+33.3 g/microns, wherein the MD Elmendorf tear is at least 11.8 g/micron.

18. The process of any of paragraphs 12 to 17 wherein the ethylene polymer is a copolymer of ethylene and one or more of butene, hexene and octene having a density of 0.920 to 0.940 g/cc.

19. The film of any of paragraphs 6 to 8, wherein the Mw/Mn of the polymer is at least one unit less than the Mw/Mn of the soluble portion.

20. A process to make a film comprising: A) selecting an ethylene polymer that is soluble in xylene at 60° C. or less, and has: i) an Mw of 150,000 g/mol or more, ii) an Mw/Mn of 2 or more, preferably 4.0 or more, iii) at least 5 mol % C3 to C20 comonomer, iv) a r₁r₂ value of less than 1.0, and v) “butyls” per 1000 carbons or 15 or more; and B) forming the ethylene polymer into a film.

21. The process of paragraph 21 wherein the comonomer comprises hexene.

22. The process of paragraph 21 or 22 wherein the an r₁r₂ value is less than 0.8.

23. A article of manufacture comprising at least 50 wt % of an ethylene copolymer having: i) an Mw of 150,000 g/mol or more, ii) an Mw/Mn of 2 or more, preferably 4.0 or more, iii) at least 5 mol % C3 to C20 comonomer, iv) a r₁r₂ value of less than 1.0, and v) “butyls” per 1000 carbons or 15 or more.

24. The article of paragraph 23 wherein the article is a film.

25. The article of paragraph 23 where the article is a blown film.

### EXAMPLES

### Tests and Materials.

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation “MD” indicating a measurement in the machine direction, and “TD” indicating a measurement in the transverse direction. Elmendorf Tear was measured as specified by ASTM D-1922. Tensile Strength at Yield was measured as specified by ASTM D-882. Tensile Strength at Break was measured as specified by ASTM D-882. Ultimate Tensile Strength was measured as specified by ASTM D-882. Tensile Peak Load was measured as specified by ASTM D-882. Tensile Energy was measured as specified by ASTM D-882. Elongation at Yield was measured as specified by ASTM D-882. Elongation at Break was measured as specified by ASTM D-882. 1% Secant Modulus was measured as specified by ASTM D-882. Melt Index, I_{2.16} refers to the melt flow rate measured according to ASTM D-1238, condition E. High Load Melt Index, I_{21.6}, refers to the melt flow rate measured according to ASTM D-1238, condition F. Density was determined measured as specified by ASTM D-1505 using chips cut from plaques compression molded in accordance with ASTM D-4703-07, aged in for 40 hrs at 23° C. plus or minus 2° C., unless specifically stated otherwise. Dart Drop (also known as Dart F₅₀, or Dart Drop Impact or Dart Drop Impact Strength) was measured as specified by ASTM D-1709, method A.

### Example 1

A 0.7 g/cc melt index polyethylene resin (having 3 mol % hexene comonomer) with a Melt Index Ratio of 31.4 and a density of 0.921 g/cc produced using a supported catalyst prepared from bis(n-propylcyclopentadienyl) hafnium dimethyl (Boulder Scientific, Colorado, USA) and Ineos™ES757 (microsphereoidal silica with a 25 micron average particle size) with alumoxane (Al:Hf ratio 99:1) in a 5000 cubic foot (approx. 142,000 liters) Unipol reactor operated at 77° C. using an ethylene partial pressure of 200 psi (1.38 MPa), a ethylene to hexene ratio of 0.0150, and 10.0 mole percent isopentane (according to the basic procedures described in US 2008-0038533) was converted into thin (0.79 mil±0.005 mil/20 micron±0.1 micron) three layered coextruded films using a W&H (Windmoeller and Hoelscher) blown film line equipped with a 9.8 inch (250 mm) die employing a 55 mil (1.4 mm) die gap (or an 87 mil (2.2 mm) die gap). The polyethylene resin is in all three layers of the film. The outside layer of the film constituted 5 microns (0.197 mils) of the film and was feed by a 60 mm (2.4 inch) smoothed bore 30:1 L/D extruder. The middle layer of the film constituted 10 microns (0.394 mils) of the film and was feed by a 90 mm (3.5 inch) grooved feed 30:1 L/D extruder. The inside layer of the film constituted 5 microns (0.197 mils) of the film and was feed by a 60 mm (2.4 inch) grooved feed 30:1 L/D extruder. The temperature of all three extruders and the die were maintained as shown in Table 6. Additional processing conditions for the films are reported in Tables 7 to 15. The properties of the films are reported in Tables 16 and 17. The polymer itself was fractionated and characterized (reported in Tables 4 and 5).

TABLE 4
Selected data on Molecular Weight Fractionations collected from product produced using bis(n-propylcyclopentadienyl)
hafnium dimethyl

| | | | Fraction | | | | | | | | | |
|---|---|---|---|---|---|---|---|---|---|---|---|---|
| Variable | Units | Parent | 1 | 2 | 3 | 4 | 5 | 6 | 7 | 8 | 9 | 10 |
| Non-Solvent | % | — | 60 | 53 | 49 | 47 | 44 | 43 | 42 | 41.9 | 41.3 | 40 |
| Recovery | % | 93.1 | 7.6 | 6.7 | 8.3 | 8.0 | 10.9 | 11.4 | 8.4 | 6.8 | 6.9 | 18.1 |

TREF Temp

| | | | | | | | | | | | | |
|---|---|---|---|---|---|---|---|---|---|---|---|---|
| Primary Peak | ° C. | 95 | 94 | 95 | 95 | 95 | 95 | 95 | 95 | 95 | 95 | 95 |
| Secondary Peak | ° C. | 68 | 75 | 75 | 75 | 74 | 63 | 62 | 64 | 66 | 66 | 69 |
| Median | | 87.5 | 87.4 | 91.5 | 93 | 92 | 91.2 | 88.7 | 84.9 | 83.6 | 79.6 | 77.5 |
| CDBI* | | 30 | 53 | 48 | 53 | 44 | 41 | 5 | 27 | 28 | 36 | 62 |

GPC Analysis

| | | | | | | | | | | | | |
|---|---|---|---|---|---|---|---|---|---|---|---|---|
| Mn | K Dalt. | 31.9 | 6.4 | 15.3 | 24.9 | 34.0 | 47.0 | 63.0 | 77.3 | 91.4 | 108.9 | 149.2 |
| Mw | K Dalt. | 127.8 | 17.9 | 30.2 | 37.3 | 47.8 | 66.7 | 92.5 | 117.5 | 141.1 | 168.4 | 253.0 |
| Mz | K Dalt. | 339.3 | 129.2 | 279.2 | 113.2 | 100.8 | 119.3 | 158.6 | 196.0 | 232.3 | 265.4 | 392.4 |
| Mw/Mn | — | 4.0 | 2.8 | 2.0 | 1.5 | 1.4 | 1.4 | 1.5 | 1.5 | 1.5 | 1.6 | 1.7 |
| Mz/Mw | — | 2.7 | 7.2 | 9.2 | 3.0 | 2.1 | 1.8 | 1.7 | 1.7 | 1.6 | 1.6 | 1.6 |

¹H-NMR

| | | | | | | | | | | | | |
|---|---|---|---|---|---|---|---|---|---|---|---|---|
| Methyls/1000 Carbons | — | 13.4 | 10.3 | 9.2 | 9.5 | 10.2 | 12.2 | 13.8 | 14.8 | 15.6 | 16.4 | 17.1 |
| Methyls/1000 Carbons** | — | 12.5 | 5.9 | 7.4 | 8.4 | 9.4 | 11.6 | 13.4 | 14.4 | 15.3 | 16.1 | 16.9 |
| Vinylenes/1000 Carbons | — | 0.1 | 0.10 | 0.11 | 0.09 | 0.09 | 0.07 | 0.08 | 0.16 | 0.11 | 0.06 | 0.03 |
| Trisubstituted Olefins/1000 | — | 0.1 | 0.28 | 0.09 | 0.01 | 0.01 | 0.01 | 0.01 | 0.09 | 0.14 | 0.08 | 0.24 |
| Carbons | | | | | | | | | | | | |
| Vinyls/1000 Carbons | — | 0.07 | 0.02 | 0.05 | 0.02 | 0.02 | 0.03 | 0.01 | 0.03 | 0.04 | 0.06 | 0.07 |
| Vinylidenes/1000 Carbons | — | 0.06 | 0.07 | 0.03 | 0.00 | 0.00 | 0.04 | 0.01 | 0.01 | 0.05 | 0.00 | 0.02 |
| Hexene | Wt % | 7.4 | 3.5 | 4.4 | 5.0 | 5.6 | 6.9 | 7.9 | 8.6 | 9.1 | 9.6 | 10.0 |
| Hexene | Mole % | 2.6 | 1.2 | 1.5 | 1.7 | 1.9 | 2.4 | 2.8 | 3.1 | 3.3 | 3.5 | 3.6 |

*Calculated according to PCT Patent Application WO 93/03093 using the calibration curve (TREF Temperature vs. mole % comonomer) for an ethylene hexene metallocene copolymer: mol % comonomer = −0.1621(TREF Elution Temperature in ° C.) + 15.976
**Corrected for end group and unsaturations

TABLE 5
Selected data on Chemical Composition Fractionations collected from product produced using bis(n-propylcyclopentadienyl)
hafnium dimethyl

| | | | Fraction | | | | | | | | | |
|---|---|---|---|---|---|---|---|---|---|---|---|---|
| Variable | Units | Parent | 1 | 2 | 3 | 4 | 5 | 6 | 7 | 8 | 9 | 10 |
| Isolation Temperature Range | ° C. | — | <36 | <51 | <59 | <65 | <71 | <77 | <83 | <87 | <91 | >91 |
| Recovery | % | 98.01 | 6.3 | 5.5 | 11.0 | 8.4 | 7.6 | 7.8 | 12.7 | 15.7 | 14.0 | 11.0 |
| Peak TREF Temp | ° C. | | 58 | 62 | 68 | 74 | 80 | 86 | 90 | 94 | 96 | 97 |
| Median TREF Temp | | | 56.3* | 60.4 | 66.4 | 72.3 | 78.1 | 83.8 | 89.0 | 92.8 | 95.2 | 96.8 |
| CDBI* | — | 30 | 99 | 99 | 98 | 96 | 95 | 24 | 86 | 76 | 64 | 45 |

GPC Analysis

| | | | | | | | | | | | | |
|---|---|---|---|---|---|---|---|---|---|---|---|---|
| Mn | K Dalt. | 31.9 | 167.7 | 88.4 | 127.4 | 116.6 | 43.1 | 27.8 | 25.6 | 27.5 | 29.5 | 33.5 |
| Mw | K Dalt. | 127.8 | 561.8 | 192.2 | 257.8 | 227.9 | 160.2 | 110.7 | 71.1 | 59.2 | 57.7 | 60.1 |
| Mz | K Dalt. | 339.3 | 3,685.3 | 350.4 | 430.9 | 393.5 | 290.6 | 238.5 | 151.9 | 116.5 | 108.3 | 109.7 |
| Mw/Mn | — | 4.00 | 3.35 | 2.17 | 2.02 | 1.95 | 3.72 | 3.99 | 2.78 | 2.16 | 1.95 | 1.80 |
| Mz/Mw | — | 5.7 | 6.7 | 1.8 | 1.7 | 1.7 | 1.8 | 2.2 | 2.1 | 2.0 | 1.9 | 1.8 |

¹H-NMR

| | | | | | | | | | | | | |
|---|---|---|---|---|---|---|---|---|---|---|---|---|
| Methyls/1000 Carbons | — | 13.4 | 34.9 | 28.8 | 24.1 | 21.2 | 17.0 | 12.8 | 8.9 | 6.3 | 5.1 | 3.8 |
| Methyls/1000 Carbons** | — | 12.5 | 34.73 | 28.48 | 23.88 | 20.96 | 16.35 | 11.79 | 7.80 | 5.28 | 4.15 | 2.96 |
| Vinylenes/1000 Carbons | — | 0.1 | 0.20 | 0.16 | 0.08 | 0.05 | 0.14 | 0.15 | 0.09 | 0.09 | 0.14 | 0.14 |
| Trisubstituted Olefins/1000 | — | 0.1 | 0.46 | 0.17 | 0.39 | 0.28 | 0.39 | 0.12 | 0.17 | 0.07 | 0.29 | 0.13 |
| Carbons | | | | | | | | | | | | |
| Vinyls/1000 Carbons | — | 0.07 | 0.16 | 0.14 | 0.19 | 0.26 | 0.09 | 0.09 | 0.05 | 0.03 | 0.12 | 0.13 |
| Vinylidenes/1000 Carbons | — | 0.06 | 0.01 | 0.05 | 0.08 | 0.06 | 0.07 | 0.10 | 0.03 | 0.00 | 0.06 | 0.03 |
| Hexene | Wt % | 7.4 | 20.64 | 16.92 | 14.18 | 12.44 | 9.70 | 7.00 | 4.63 | 3.13 | 2.46 | 1.76 |
| Hexene | Mole % | 2.6 | 8.07 | 6.43 | 5.28 | 4.58 | 3.50 | 2.47 | 1.61 | 1.08 | 0.84 | 0.60 |

*Calculated according to PCT Patent Application WO 93/03093 using the calibration curve (TREF Temperature vs. mole % comonomer) for an ethylene hexene metallocene copolymer: mol % comonomer = −0.1621 (TREF Elution Temperature in ° C.) + 15.976
**Corrected for end group and unsaturations

TABLE 6
Extruder and Die Conditions used to make films 1, 2, 4-23

| | Temperature (° C.) | | |
|---|---|---|---|
| Parameter | Average | Standard Deviation | Cv* |

Extruders Zone

| | | | |
|---|---|---|---|
| 1 | 180 | 0.34 | 0.2 |
| 2 | 190 | 0.00 | 0.0 |
| 3 | 190 | 0.14 | 0.1 |
| 4 | 193 | 4.98 | 2.6 |
| Screen Changer | 190 | 0.00 | 0.0 |
| Adapter | 190 | 0.00 | 0.0 |

Die Predistributor

| | | | |
|---|---|---|---|
| Extruder. A | 193 | 1.32 | 0.7 |
| Extruder. B | 194 | 1.53 | 0.8 |
| Extruder. C | 190 | 0.24 | 0.1 |

Die

| | | | |
|---|---|---|---|
| Bottom | 190 | 0.00 | 0.0 |
| Body-Z5 | 190 | 0.00 | 0.0 |
| Body-Z6 | 190 | 0.39 | 0.2 |
| Lip outer ring | 190 | 0.24 | 0.1 |
| Lip insert | 195 | 3.65 | 1.9 |

*Coefficient of Variance

TABLE 7
Selected Processing Conditions for Film 1

| | | Layer | | |
|---|---|---|---|---|
| Parameters | Units | A (outside) | B (middle) | C (inside) |
| Screw Speed | (rpm) | 38.4 | 22.7 | 36.2 |
| Motor Load | (%) | 68.00 | 48.00 | 40.00 |
| Output | (kg/h) | 35 | 70.5 | 34.9 |
| Specific output | (kg/h/rpm) | 0.9 | 3.1 | 1.0 |
| Melt Temperatures | (° C.) | 204 | 205 | 202 |
| Melt pressure | (bar) | 317 | 303 | 311 |

TABLE 8
Selected Processing Conditions for Films 2 and 4

| | | Layer | | | | | |
|---|---|---|---|---|---|---|---|
| | | A (outside) | | B (middle) | | C (inside) | |
| Parameters | Units | Average | Standard Deviation | Average | Standard Deviation | Average | Standard Deviation |
| Screw Speed | (rpm) | 44 | 0.46 | 26 | 0.81 | 41 | 0.84 |
| Motor Load | (%) | 74 | 1.15 | 54 | 1.15 | 43 | 1.00 |
| Output | (kg/h) | 40 | 0.21 | 80 | 0.45 | 40 | 0.25 |
| Specific output | (kg/h/rpm) | 1 | 0.01 | 3 | 0.10 | 1 | 0.03 |
| Melt Temperatures | (° C.) | 208 | 0.58 | 207 | 1.15 | 204 | 0.00 |
| Melt pressure | (bar) | 342 | 3.51 | 326 | 1.73 | 340 | 5.51 |

TABLE 9
Selected Processing Conditions for Film 5, 6, 7, 8, 9 and 10

| | | Layer | | | | | |
|---|---|---|---|---|---|---|---|
| | | A (outside) | | B (middle) | | C (inside) | |
| Parameters | Units | Average | Standard Deviation | Average | Standard Deviation | Average | Standard Deviation |
| Screw Speed | (rpm) | 55 | 0.24 | 32 | 0.34 | 51 | 0.37 |
| Motor Load | (%) | 81 | 0.98 | 55 | 2.50 | 44 | 2.79 |
| Output | (kg/h) | 50 | 0.21 | 100 | 0.74 | 50 | 0.31 |
| Specific output | (kg/h/rpm) | 1 | 0.00 | 3 | 0.04 | 1 | 0.01 |
| Melt Temperatures | (° C.) | 214 | 0.52 | 213 | 0.55 | 208 | 0.00 |
| Melt pressure | (bar) | 382 | 2.74 | 362 | 2.79 | 376 | 5.27 |

TABLE 10
Selected Processing Conditions for Film 11 and 12

| | | Layer | | | | | |
|---|---|---|---|---|---|---|---|
| | | A (outside) | | B (middle) | | C (inside) | |
| | | | Standard | | Standard | | Standard |
| Parameters | Units | Average | Deviation | Average | Deviation | Average | Deviation |
| Screw Speed | (rpm) | 67 | 0.71 | 39 | 1.13 | 61 | 1.06 |
| Motor Load | (%) | 87 | 0.00 | 59 | 1.41 | 45 | 2.12 |
| Output | (kg/h) | 60 | 0.42 | 121 | 0.78 | 60 | 0.14 |
| Specific | (kg/h/rpm) | 1 | 0.00 | 3 | 0.11 | 1 | 0.01 |
| output | | | | | | | |
| Melt | (° C.) | 222 | 0.00 | 217 | 0.71 | 213 | 1.41 |
| Temperatures | | | | | | | |
| Melt pressure | (bar) | 408 | 4.95 | 390 | 0.00 | 404 | 6.36 |

TABLE 11
Selected Processing Conditions for Film 13

| | | Layer | | |
|---|---|---|---|---|
| Parameters | Units | A (outside) | B (middle) | C (inside) |
| Screw Speed | (rpm) | 39.4 | 21.7 | 33.0 |
| Motor Load | (%) | 68.00 | 54.00 | 45.00 |
| Output | (kg/h) | 34.9 | 70 | 35 |
| Specific output | (kg/h/rpm) | 0.9 | 3.2 | 1.1 |
| Melt | (° C.) | 205 | 206 | 202 |
| Temperatures | | | | |
| Melt pressure | (bar) | 342 | 335 | 338 |

TABLE 12
Selected Processing Conditions for Film 14 and 15

| | | Layer | | | | | |
|---|---|---|---|---|---|---|---|
| | | A (outside) | | B (middle) | | C (inside) | |
| Parameters | Units | Average | Standard Deviation | Average | Standard Deviation | Average | Standard Deviation |
| Screw Speed | (rpm) | 44 | 0.28 | 26 | 0.07 | 40 | 0.21 |
| Motor Load | (%) | 73 | 0.71 | 54 | 0.71 | 45 | 0.00 |
| Output | (kg/h) | 40 | 0.14 | 80 | 0.35 | 40 | 0.14 |
| Specific output | (kg/h/rpm) | 1 | 0.01 | 3 | 0.02 | 1 | 0.01 |
| Melt Temperatures | (° C.) | 209 | 0.71 | 208 | 0.00 | 204 | 0.00 |
| Melt pressure | (bar) | 346 | 9.90 | 338 | 2.83 | 344 | 6.36 |

TABLE 13
Selected Processing Conditions for Film 16, 17, 18, 19, 20 and 21

| | | Layer | | | | | |
|---|---|---|---|---|---|---|---|
| | | A (outside) | | B (middle) | | C (inside) | |
| Parameters | Units | Average | Standard Deviation | Average | Standard Deviation | Average | Standard Deviation |
| Screw Speed | (rpm) | 56 | 0.54 | 32 | 0.46 | 50 | 0.71 |
| Motor Load | (%) | 81 | 0.52 | 57 | 1.63 | 47 | 2.07 |
| Output | (kg/h) | 50 | 0.33 | 100 | 0.50 | 50 | 0.55 |
| Specific output | (kg/h/rpm) | 1 | 0.01 | 3 | 0.04 | 1 | 0.01 |
| Melt Temperatures | (° C.) | 216 | 0.55 | 213 | 0.75 | 208 | 0.52 |
| Melt pressure | (bar) | 387 | 5.80 | 379 | 5.06 | 384 | 4.71 |

TABLE 14
Selected Processing Conditions for Film 22 and 23

| | | Layer | | | | | |
|---|---|---|---|---|---|---|---|
| | | A (outside) | | B (middle) | | C (inside) | |
| Parameters | Units | Average | Standard Deviation | Average | Standard Deviation | Average | Standard Deviation |
| Screw Speed | (rpm) | 67 | 0.42 | 40 | 0.14 | 61 | 0.21 |
| Motor Load | (%) | 86 | 0.00 | 58 | 4.95 | 47 | 2.12 |
| Output | (kg/h) | 60 | 0.07 | 120 | 0.28 | 60 | 0.78 |
| Specific output | (kg/h/rpm) | 1 | 0.01 | 3 | 0.00 | 1 | 0.02 |
| Melt Temperatures | (° C.) | 223 | 1.41 | 218 | 0.00 | 213 | 1.41 |
| Melt pressure | (bar) | 416 | 5.66 | 408 | 0.00 | 412 | 1.41 |

TABLE 15
Selected Processing conditions for films of Example 1 by die gap

| | | | | | | | |
|---|---|---|---|---|---|---|---|
| | | | Frost | | | | Lay |
| | Output/ | Total | Line | Haul-off | Basket | | Flat |
| | cm die | Output | Height | speed | Height | | Width |
| Run Number | (kg/hr/cm) | (kg/h) | (mm) | (m/min) | (mm) | B.U.R | (mm) |

Die gap 1.4 mm

| | | | | | | | |
|---|---|---|---|---|---|---|---|
| 1 | 1.79 | 140.4 | 780 | 64.7 | 1010 | 2.5 | 978 |
| 2 | 2.05 | 160.9 | 770 | 92.4 | 1027 | 2 | 787 |
| 4 | 2.05 | 160.8 | 730 | 61.5 | 998 | 3 | 985 |
| 5 | 2.54 | 199.3 | 770 | 92.2 | 1010 | 2.5 | 982 |
| 6 | 2.55 | 200.5 | 770 | 92.1 | 1074 | 2.5 | 985 |
| 7 | 2.58 | 202.3 | | 92.4 | 1057 | 2.5 | 985 |
| 8 | 2.54 | 199.8 | 920 | 127.9 | 1081 | 1.8 | 706 |
| 9 | 2.56 | 200.9 | 810 | 92.2 | 1056 | 2.4 | 982 |
| 10 | 2.55 | 200.1 | 770 | 72 | 1043 | 3.2 | 1256 |
| 11 | 3.05 | 239.6 | 860 | 138.4 | 1091 | 2 | 787 |
| 12 | 3.07 | 241.1 | 790 | 92.3 | 1056 | 3 | 1175 |

2.2 mm die gap

| | | | | | | | |
|---|---|---|---|---|---|---|---|
| 13 | 1.78 | 139.9 | 730 | 64.6 | 972 | 2.5 | 985 |
| 14 | 2.04 | 160 | 740 | 92.3 | 1021 | 2.0 | 789 |
| 15 | 2.03 | 159.6 | 730 | 61.5 | 1006 | 3 | 1176 |
| 16 | 2.54 | 199.4 | 820 | 92.3 | 1044 | 2.5 | 982 |
| 17 | 2.55 | 200.6 | 820 | 92.2 | 1070 | 2.5 | 983 |
| 18 | 2.54 | 199.3 | 820 | 92.1 | 1116 | 2.5 | 980 |
| 19 | 2.55 | 199.9 | | 127.9 | 1212 | 1.8 | 104 |
| 20 | 2.55 | 200.2 | 820 | 92.1 | 1119 | 2.5 | 984 |
| 21 | 2.54 | 199.5 | | 72.1 | 1078 | 3.2 | 1253 |
| 22 | 3.06 | 240.2 | 1020 | 138.3 | 1268 | 2 | 784 |
| 23 | 3.05 | 239.4 | | 92.3 | 1130 | 3 | 1177 |

B.U.R (or BUR) is blow up ratio.

TABLE 16
Selected Properties of films of Example 1

| | | | | | Elongation | |
|---|---|---|---|---|---|---|
| | 1% Secant | | Tensile at | | at | |
| | Modulus | | Break | | Break | |
| Film | MD | TD | MD | TD | MD | TD |
| ID# | (MPa) | (MPa) | (MPa) | (MPa) | (%) | (%) |
| 1 | 254 | 313 | 65 | 49.3 | 346 | 605 |
| 2 | 262 | 324 | 67.5 | 49.9 | 279 | 652 |
| 4 | 241 | 294 | 65.1 | 46.1 | 359 | 595 |
| 5 | 258 | 324 | 72.2 | 42.1 | 340 | 575 |
| 6 | 260 | 292 | 71.9 | 47.1 | 318 | 583 |
| 7 | 257 | 318 | 69.1 | 49.4 | 319 | 620 |
| 8 | 250 | 298 | 75.6 | 41.6 | 282 | 621 |
| 9 | 243 | 297 | 67.2 | 50.6 | 314 | 631 |
| 10 | 241 | 298 | 63.5 | 52.8 | 343 | 608 |
| 11 | 258 | 312 | 75.7 | 46.9 | 258 | 664 |
| 12 | 239 | 279 | 74.1 | 56.7 | 360 | 612 |
| 13 | 255 | 337 | 67.2 | 52.7 | 290 | 666 |
| 14 | 268 | 323 | 72.1 | 46.9 | 290 | 667 |
| 15 | 239 | 286 | 63.2 | 49.3 | 348 | 600 |
| 16 | 243 | 294 | 70.2 | 49.6 | 310 | 637 |
| 17 | 262 | 283 | 77.8 | 51.1 | 333 | 620 |
| 18 | 243 | 276 | 64 | 51.8 | 302 | 625 |
| 19 | 233 | 255 | 73.1 | 48.2 | 282 | 660 |
| 20 | 245 | 281 | 77.5 | 48.6 | 322 | 611 |
| 21 | 237 | 268 | 75.8 | 52.6 | 369 | 601 |
| 22 | 248 | 278 | 66.7 | 50.9 | 273 | 665 |
| 23 | 238 | 265 | 75.4 | 53.5 | 342 | 605 |

TABLE 17
Selected Properties of films of Example 1

| | Dart | Elmendorf tear | | | Dart Drop/MD |
|---|---|---|---|---|---|
| | Impact* | MD | TD | MD/TD | Elmendorf Tear |
| Film ID# | (g/micron) | (g/micron) | (g/micron) | Ratio | ratio |
| 1 | 30 | 19 | 20 | 0.93 | 1.62 |
| 2 | 12 | 32 | 24 | 1.35 | 0.36 |
| 4 | 36 | 18 | 18 | 0.98 | 2.01 |
| 5 | 24 | 21 | 20 | 1.05 | 1.11 |
| 6 | 25 | 25 | 23 | 1.11 | 0.98 |
| 7 | 32 | 21 | 20 | 1.05 | 1.52 |
| 8 | 14 | 36 | 28 | 1.3 | 0.37 |
| 9 | 26 | 25 | 21 | 1.21 | 1.03 |
| 10 | 28 | 16 | 19 | 0.87 | 1.76 |
| 11 | 11 | 33 | 26 | 1.25 | 0.34 |
| 12 | 35 | 17 | 19 | 0.92 | 1.99 |
| 13 | 18 | 25 | 20 | 1.21 | 0.71 |
| 14 | 14 | 27 | 21 | 1.28 | 0.52 |
| 15 | 25 | 15 | 18 | 0.85 | 1.62 |
| 16 | 19 | 25 | 20 | 1.2 | 0.78 |
| 17 | 28 | 25 | 19 | 1.28 | 1.11 |
| 18 | 18 | 21 | 21 | 1.01 | 0.85 |
| 19 | 12 | 34 | 26 | 1.32 | 0.34 |
| 20 | 23 | 21 | 21 | 1.01 | 1.09 |
| 21 | 33 | 19 | 18 | 1.03 | 1.75 |
| 22 | 14 | 31 | 23 | 1.35 | 0.45 |
| 23 | 29 | 20 | 19 | 1.1 | 1.42 |

*(Method A)

### Example 2

A 0.71 g/10 min MI polyethylene resin (having 3 mol % hexene comonomer, a Melt Index Ratio of 32.4, density of 0.9205 g/cc, Mw/Mn of 3.77 and Mz/Mw of 2.69) produced following the methods described in U.S. Pat. No. 6,956,088 was converted into thin (20 micron±1.5 micron, 0.73 mil±0.06 mil,) monolayer films using a Sano blown film line employing a 60 mm (2.5 inch) smoothed bore 30:1 L/D extruder equipped with a 250 mm (10 inch) die operated using 2.5 blow up ratio. The polymer was fractionated and characterized as reported in Tables 18 to 22. The processing conditions for the films are reported in Table 23. The properties of the films are reported in Table 24.

TABLE 18
Selected data on Molecular Weight Fractionations of Example 2

| | | | Fraction | | | | | | | | | |
|---|---|---|---|---|---|---|---|---|---|---|---|---|
| Variable | Units | Parent | 1 | 2 | 3 | 4 | 5 | 6 | 7 | 8 | 9 | 10 |
| Non-Solvent | % | — | 60 | 53 | 49 | 47 | 44 | 43 | 42 | 41.9 | 41.3 | 40 |
| Recovery | % | | 10.9 | 5.0 | 9.0 | 9.0 | 6.8 | 7.0 | 15.4 | 9.2 | 9.7 | 18.2 |

TREF Temp

| | | | | | | | | | | | | |
|---|---|---|---|---|---|---|---|---|---|---|---|---|
| Primary Peak | ° C. | 92.6 | 90.6 | 91.8 | 92.5 | 92.4 | 92.5 | 92.4 | 92.2 | 92.4 | 92.3 | 94.4 |
| Secondary Peak | ° C. | 60 | 76.4 | 76.9 | 76.7 | 76.3 | 52.9 | 52.6 | 57.7 | 58 | 62.8 | 70.4 |
| Median Temp | | 84.4 | 84.2 | 88.8 | 90.6 | 89.3 | 87.7 | 83.1 | 78.4 | 75.1 | 75.5 | 78.3 |
| CDBI* | — | 16 | 62 | 64 | 62 | 55 | 49 | 28 | 28 | 33 | 39 | 40 |

GPC Analysis

| | | | | | | | | | | | | |
|---|---|---|---|---|---|---|---|---|---|---|---|---|
| Mn | K Dalt. | 32.6 | 5.5 | 13.0 | 23.2 | 33.5 | 49.7 | 67.5 | 82.9 | 106.5 | 137.7 | 180.9 |
| Mw | K Dalt. | 129.8 | 10.37 | 21.8 | 35.2 | 52.2 | 84.5 | 117.9 | 141.0 | 183.8 | 222.2 | 287.54 |
| Mz | K Dalt. | 361.7 | 14.9 | 58.7 | 74.9 | 113.4 | 181.5 | 233.9 | 253.5 | 328.4 | 364.0 | 446.4 |
| Mw/Mn | — | 4 | 1.9 | 1.7 | 1.5 | 1.6 | 1.7 | 1.7 | 1.7 | 1.7 | 1.6 | 1.6 |
| Mz/Mw | — | 2.8 | 1.4 | 2.7 | 2.1 | 2.2 | 2.1 | 2.0 | 1.8 | 1.8 | 1.6 | 1.6 |

¹H-NMR

| | | | | | | | | | | | | |
|---|---|---|---|---|---|---|---|---|---|---|---|---|
| CH3/1000 C. | — | 15.9 | 18.6 | 10.7 | 12.0 | 13.5 | 15.4 | 16.6 | 16.9 | 17.2 | 17.1 | 16.5 |
| CH3/1000 C.** | — | 15.0 | 13.5 | 8.6 | 10.8 | 12.7 | 14.8 | 16.2 | 16.6 | 16.9 | 16.9 | 16.3 |
| Vinylenes/1000 C. | — | 0.06 | 0.16 | 0.18 | 0.15 | 0.05 | 0.10 | 0.02 | 0.29 | 0.06 | 0.09 | 0.08 |
| Trisubstituted | — | 0.07 | 0.04 | 0.12 | 0.02 | 0.00 | 0.05 | 0.18 | 0.32 | 0.05 | 0.08 | 0.00 |
| Olefins/1000 C. | | | | | | | | | | | | |
| Vinyls/1000 C. | — | 0.02 | 0.07 | 0.08 | 0.05 | 0.03 | 0.07 | 0.06 | 0.06 | 0.00 | 0.02 | 0.07 |
| Vinylidenes/1000 C. | — | 0.00 | 0.01 | 0.00 | 0.07 | 0.03 | 0.00 | 0.01 | 0.01 | 0.02 | 0.00 | 0.04 |
| Hexene | Wt % | 8.9 | 8.0 | 5.1 | 6.4 | 7.5 | 8.8 | 9.6 | 9.8 | 10.1 | 10.0 | 9.7 |
| Hexene | Mole % | 3.2 | 2.9 | 1.8 | 2.3 | 2.7 | 3.2 | 3.5 | 3.5 | 3.6 | 3.6 | 3.5 |

C13-NMR

| | | | | | | | | | | | | |
|---|---|---|---|---|---|---|---|---|---|---|---|---|
| Methyls/1000 C. | — | 0.3 | 0.4 | 0.4 | 0.5 | 0.2 | 0.2 | 0.2 | 0.2 | 0.1 | — | — |
| Ethyls/1000 C. | — | 0.04 | ND | ND | 0.1 | trace | trace | trace | ND | ND | — | — |
| Butyls/1000 C. | — | 15.53 | 7.1 | 9.7 | 11.6 | 14.1 | 16.8 | 18.3 | 18 | 18.3 | — | — |
| Polypropylene | Wt % | 0.13 | 1.2 | 0.1 | ND | ND | ND | ND | ND | ND | — | — |
| Hexene | Wt % | 9.32 | 4.26 | 5.81 | 6.96 | 8.45 | 10.05 | 11 | 10.8 | 10.99 | — | — |
| Hexene | Mole % | 3.31 | 1.46 | 2.02 | 2.43 | 2.98 | 3.59 | 3.96 | 3.88 | 3.95 | — | — |
| Run Number | — | 3.14 | 1.35 | 1.87 | 2.32 | 2.82 | 3.42 | 3.77 | 3.73 | 3.8 | — | — |
| Avg. E_{L} | — | 31 | 72 | 53 | 42 | 34 | 28 | 25 | 26 | 25 | — | — |
| r₁r₂ | — | 1.66 | 5.3 | 4.9 | 2.4 | 2.2 | 1.25 | 1.21 | 1.02 | 1.2 | — | — |

*Calculated according to PCT Patent Application WO 93/03093 using the calibration curve (TREF Temperature vs. mole % comonomer) for an ethylene hexene metallocene copolymer: mol % comonomer = −0.1621 (TREF Elution Temperature in ° C.) + 15.976
**Corrected for end group and unsaturations

TABLE 19
Selected Data on Chemical Composition Fractions of Example 2

| | | | Fraction | | | | | | | | | | |
|---|---|---|---|---|---|---|---|---|---|---|---|---|---|
| Variable | Units | Parent | 1 | 2 | 3 | 4 | 5 | 6 | 7 | 8 | 9 | 10 | 11 |
| Isolation Temperature | ° C. | — | <15 | <36 | <51 | <59 | <65 | <71 | <77 | <83 | <87 | <91 | >91 |
| Recovery | | | | | | | | | | | | | |
| 1st Fractionation | % | — | 1.7 | 9.1 | 2.5 | 14.9 | 6.8 | 5.9 | 6.2 | 8 | 11.3 | 15.3 | 18.4 |
| 2nd Fractionation | % | — | 13.6 | | 6 | 11.9 | 6.8 | 6 | 7.2 | 9.1 | 17.8 | 16.2 | 5.4 |

TREF Temp

| | | | | | | | | | | | | | |
|---|---|---|---|---|---|---|---|---|---|---|---|---|---|
| Peak Temp | ° C. | — | 39 | 52 | 59.3 | 64.4 | 73.5 | 78.7 | 83.5 | 88.5 | 92.0 | 93.8 | 95.7 |
| Median Temp | | 84.4 | 39 | 52 | 59.3 | 64.4 | 73.5 | 78.7 | 83.5 | 88.5 | 92.1 | 93.8 | 95.7 |
| CDBI* | | 16 | 92 | 97 | 94 | 97 | 94 | 93 | 87 | 91 | 85 | 84 | 70 |

GPC Analysis

| | | | | | | | | | | | | | |
|---|---|---|---|---|---|---|---|---|---|---|---|---|---|
| Mn | k Dalt. | 32.6 | 14.5 | 43.6 | 19.2 | 30.4 | 37.4 | 27.3 | 24.1 | 24.0 | 23.9 | 26.4 | 31.4 |
| Mw | k Dalt. | 129.8 | 230.8 | 248.9 | 169.0 | 207.1 | 170.4 | 130.7 | 94.6 | 70.0 | 59.1 | 56.8 | 60.8 |
| Mz | k Dalt. | 361.7 | 443.0 | 458.4 | 383.1 | 398.6 | 342.2 | 283.9 | 209.9 | 155.2 | 135.1 | 116.3 | 119.6 |
| Mw/Mn | — | 4 | 15.9 | 5.7 | 8.8 | 6.8 | 4.6 | 4.8 | 3.9 | 2.9 | 2.5 | 2.2 | 1.9 |
| Mz/Mw | — | 2.8 | 1.9 | 1.8 | 2.3 | 1.9 | 2 | 2.2 | 2.2 | 2.2 | 2.3 | 2 | 2 |

¹H-NMR Analysis

| | | | | | | | | | | | | | |
|---|---|---|---|---|---|---|---|---|---|---|---|---|---|
| CH3/1000 C. | — | 15.9 | 47.1 | 31.4 | 29.4 | 26.5 | 20.1 | 16.2 | 12.1 | 8.8 | 6.3 | 5.5 | 5.5 |
| CH₃/1000 C.** | — | 15 | 45.2 | 30.8 | 27.9 | 25.6 | 19.4 | 15.2 | 10.9 | 7.6 | 5.1 | 4.4 | 4.6 |
| Vinylenes/1000 C. | — | 0.05 | 0 | 0.04 | 0.14 | 0.28 | 0.09 | 0.11 | 0.07 | 0.08 | 0.13 | 0.03 | 0.06 |
| Trisubstituted | — | 0.08 | 0.23 | 0.06 | 0.15 | 0.36 | 0.02 | 0.08 | 0.07 | 0.11 | 0.32 | 0.05 | 0.13 |
| olefins/1000 C. | | | | | | | | | | | | | |
| Vinyls/1000 C. | — | 0 | 0.13 | 0.02 | 0.03 | 0.08 | 0.01 | 0.05 | 0.05 | 0.02 | 0.01 | 0.07 | 0.02 |
| Vinylidenes/1000 C. | — | 0 | 0.02 | 0.02 | 0.05 | 0 | 0.01 | 0.02 | 0.03 | 0 | 0.01 | 0.01 | 0.03 |
| Hexene | Wt % | 8.9 | 27.1 | 16.8 | 16.6 | 15.2 | 11.5 | 9 | 6.5 | 4.5 | 3 | 2.6 | 2.7 |
| Hexene | Mole % | 3.2 | 11 | 7 | 6.3 | 5.7 | 4.2 | 3.2 | 2.3 | 1.6 | 1 | 0.9 | 0.9 |

| | | | Fraction | | | | | | | | | | |
|---|---|---|---|---|---|---|---|---|---|---|---|---|---|
| Variable | Units | Parent | 1 | 2 | 3 | 4** | 5 | 6 | 7 | 8 | 9 | 10 | 11 |

C13-NMR Analysis

| | | | | | | | | | | | | |
|---|---|---|---|---|---|---|---|---|---|---|---|---|
| Methyls/1000 C. | — | 0.3 | ND | ND | ND | 0.1 | 0.2 | 0.3 | 0.44 | 0.43 | 0.42 | 0.38 |
| Ethyls/1000 C. | — | 0.04 | 0.2 | trace | ND | 0.1 | Trace | ND | ND | 0.1 | 0.1 | 0.09 |
| Butyls/1000 C. | — | 15.53 | 40.03 | 30.6 | 26.72 | 20.58 | 15.52 | 11.44 | 7.22 | 4.79 | 3.85 | 3.28 |
| Polypropylene | Wt % | 0.13 | ND | ND | 0.06 | 0.09 | 0.18 | 0.05 | 0.02 | 0.03 | ND | 0.43 |
| Hexene | Wt % | 9.32 | 24.02 | 18.36 | 16.03 | 12.35 | 9.31 | 6.86 | 4.33 | 2.88 | 2.31 | 1.97 |
| Hexene | Mole % | 3.31 | 9.53 | 6.98 | 5.98 | 4.49 | 3.31 | 2.4 | 1.49 | 0.98 | 0.78 | 0.66 |
| Run Number | — | 3.14 | 8.88 | 6.71 | 5.68 | 4.31 | 3.23 | 2.35 | 1.46 | 0.97 | 0.77 | 0.65 |
| Avg. E_{L} | — | 31 | 10 | 14 | 17 | 22 | 30 | 42 | 67 | 102 | 129 | 152 |
| r₁r₂ | — | 1.66 | 0.68 | 0.53 | 1 | 0.87 | 0.72 | 0.91 | 1.2 | 0.8 | 1.82 | 2.3 |

*Calculated according to PCT Patent Application WO 93/03093 using the calibration curve (TREF Temperature vs. mole % comonomer) for an ethylene hexene metallocene copolymer: mol % comonomer = −0.1621 (TREF Elution Temperature in ° C.) + 15.976
**Corrected for end groups.
**run on 400 MHz ¹³CNMR.

TABLE 20
Selected Non Isothermal Data of Example 2

| | Crystallization | | | | | | | | | | |
|---|---|---|---|---|---|---|---|---|---|---|---|
| | (° C.) | | Melting (° C.) | | Melting delta J/g | | Degree | Density* | | mol % BP/ | |
| Description | Peak 1 | Peak 2 | Peak 1 | Peak 2 | Hc | Hm | of Crystallinity | (g/cc) | wt % Hexene** | 100 C. (OA) | 100 C. (Chain) |
| PARENT | 109.36 | | 122.42 | | 110.3 | 106.6 | 0.37 | — | 9.5 | 1.56 | 1.66 |

Solvent/Non-slovent Fractions

| | | | | | | | | | | | |
|---|---|---|---|---|---|---|---|---|---|---|---|
| F1 | 113.13 | NA | 124.87 | NA | 178.39 | 147.38 | 0.51 | 0.9225 | 8.120 | 1.35 | 1.42 |
| F2 | 112.63 | NA | 124.87 | NA | 174.66 | 155.31 | 0.54 | 0.918 | 5.130 | 0.86 | 0.89 |
| F3 | 111.33 | NA | 123.7 | NA | 169.21 | 127.77 | 0.44 | 0.9257 | 6.477 | 1.08 | 1.13 |
| F4 | 108.97 | 63.13 | 122.87 | NA | 149.60 | 110.22 | 0.38 | 0.918 | 7.600 | 1.27 | 1.34 |
| F5 | 106.17 | 62.83 | 121.87 | NA | 126.52 | 95.99 | 0.33 | 0.9180 | 8.904 | 1.48 | 1.57 |
| F6 | 103.83 | 62.83 | 119.2 | NA | 115.77 | 74.40 | 0.26 | 0.905 | 9.714 | 1.62 | 1.73 |
| F7 | 102.66 | 61.3 | 118.36 | 74.2 | 107.81 | 69.29 | 0.24 | 0.903 | 9.940 | 1.66 | 1.78 |
| F8 | 101.63 | 62.47 | 117.37 | 78.87 | 92.25 | 60.26 | 0.21 | 0.9021 | 10.165 | 1.69 | 1.81 |
| F9 | 100.3 | 63.13 | 116.53 | 80.2 | 89.53 | 60.72 | 0.21 | 0.9016 | 10.141 | 1.69 | 1.81 |
| F10 | 101.13 | 72.63 | 116.2 | 86.5 | 85.18 | 59.82 | 0.21 | 0.9312 | 9.809 | 1.63 | 1.74 |

TREF Fractions

| | | | | | | | | | | | |
|---|---|---|---|---|---|---|---|---|---|---|---|
| F1 | 44.33 | 63.5 | 70.53 | NA | 14.63 | 10.48 | 0.04 | 0.8902 | 27.1 | 4.52 | 5.48 |
| F2 | 58.13 | NA | 73.2 | 117.2 | 38.34 | 29.61 | 0.1 | 0.8943 | 18.5 | 3.08 | 3.53 |
| F3 | — | — | — | — | — | — | — | — | 16.8 | 2.79 | 3.14 |
| F4 | 76.17 | 45.17 | 87.03 | NA | 57.2 | 42.72 | 0.15 | 0.9152 | 15.4 | 2.56 | 2.85 |
| F5 | 88.47 | 52.97 | 98.36 | 106.5 | 79.7 | 60.55 | 0.21 | 0.9245 | 11.6 | 1.94 | 2.10 |
| F6 | 94.63 | 59.97 | 109.7 | NA | 90.28 | 87.04 | 0.3 | 0.91 | 9.1 | 1.52 | 1.61 |
| F7 | 99.97 | 63.97 | 113.87 | NA | 113.2 | 106.97 | 0.37 | 0.9122 | 6.6 | 1.09 | 1.13 |
| F8 | 104.97 | 67.97 | 117.87 | NA | 117.95 | 120.4 | 0.42 | 0.9121 | 4.6 | 0.76 | 0.76 |
| F9 | 109.13 | 69.47 | 121.7 | NA | 136.12 | 133.28 | 0.46 | 0.9121 | 3.1 | 0.51 | 0.52 |
| F10 | 109.8 | 70.3 | 123.37 | NA | 153 | 146.61 | 0.51 | 0.9249 | 2.7 | 0.44 | 0.44 |

*Determined by compression molding for 1 minute at an unspecified pressure and elevated temperature prior to being quenched to room temperature.
**See Table 19 Hexene wt % determined by ¹H-NMR Analysis.

TABLE 21
Triad Distributions of Parent and Molecular Weight Fractions
of Example 2

| | Triad (Mole Fraction) | | | | | |
|---|---|---|---|---|---|---|
| | [HHH] | [HHE] | [EHE] | [HEH] | [EEH] | [EEE] |
| Parent | 0.0005 | 0.0025 | 0.0301 | 0.0019 | 0.0585 | 0.9065 |
| Fraction 1 | 0.0007 | 0.0006 | 0.0133 | 0.0013 | 0.0245 | 0.9596 |
| Fraction 2 | 0.0009 | 0.0017 | 0.0175 | 0.0022 | 0.0335 | 0.9441 |
| Fraction 3 | 0.0008 | 0.0013 | 0.0230 | 0.0026 | 0.0422 | 0.9302 |
| Fraction 4 | 0.0008 | 0.0026 | 0.0278 | 0.0029 | 0.0508 | 0.9154 |
| Fraction 5 | 0.0001 | 0.0029 | 0.0335 | 0.0030 | 0.0629 | 0.8975 |
| Fraction 6 | 0.0006 | 0.0027 | 0.0372 | 0.0035 | 0.0687 | 0.8872 |
| Fraction 7 | 0.0004 | 0.0023 | 0.0368 | 0.0030 | 0.0689 | 0.8886 |
| Fraction 8 | 0.0007 | 0.0024 | 0.0371 | 0.0035 | 0.0699 | 0.8865 |

TABLE 22
Triad Distributions of Chemical Composition Fractions of Example 2

| | Triad (Mole Fraction) | | | | | |
|---|---|---|---|---|---|---|
| Fraction | [HHH] | [HHE] | [EHE] | [HEH] | [EEH] | [EEE] |
| Fraction 1 & 2 | 0.0018 | 0.0096 | 0.0840 | 0.0121 | 0.1518 | 0.7408 |
| Fraction 3 | 0.0000 | 0.0054 | 0.0644 | 0.0059 | 0.1194 | 0.8055 |
| Fraction 4 | 0.0015 | 0.0043 | 0.0550 | 0.0052 | 0.1036 | 0.8304 |
| Fraction 5 | 0.0005 | 0.0025 | 0.0418 | 0.0030 | 0.0802 | 0.8720 |
| Fraction 6 | 0.0000 | 0.0017 | 0.0315 | 0.0015 | 0.0617 | 0.9038 |
| Fraction 7 | 0.0001 | 0.0009 | 0.0230 | 0.0014 | 0.0437 | 0.9309 |
| Fraction 8 | 0.0001 | 0.0004 | 0.0144 | 0.0005 | 0.0278 | 0.9568 |
| Fraction 9 | 0.0000 | 0.0002 | 0.0096 | 0.0003 | 0.0186 | 0.9713 |
| Fraction 10 | 0.0000 | 0.0002 | 0.0076 | 0.0002 | 0.0151 | 0.9770 |
| Fraction 11 | 0.0000 | 0.0001 | 0.0065 | 0.0002 | 0.0123 | 0.9808 |

TABLE 23
Selected Processing Conditions for films of Example 2

| | | Film Designation | | | | |
|---|---|---|---|---|---|---|
| Parameter | Units | 24 | 25 | 26 | 27 | 28 |
| Die Gap | (mm) | 1.52 | 1.52 | 1.91 | 1.91 | 1.91 |
| FLH | (mm) | 737 | 838 | 737 | 737 | 737 |
| Blow Up Ratio | — | 2.5 | 2.5 | 2.5 | 2.5 | 2.5 |
| Screw Speed | (rpm) | 50.7 | 50.3 | 49.4 | 49.4 | 49.7 |
| Line Speed | (m/min) | 69 | 68 | 69 | 84 | 69 |
| Output rate | (Kg/hr) | 145 | 144 | 142 | 142 | 141 |
| Die Throughput Rate | Kg/h/cm die cir. | 3 | 3 | 3 | 3 | 3 |
| Gauge | (micron) | 19.3 | 18.8 | 19.3 | 16.8 | 19.8 |

Temperature Profile

| | | | | | | |
|---|---|---|---|---|---|---|
| Barrel Zone 1 | (° C.) | 171 | 182 | 154 | 154 | 154 |
| Barrel Zone 2 | (° C.) | 204 | 232 | 204 | 204 | 204 |
| Barrel Zone 3 | (° C.) | 193 | 216 | 193 | 193 | 182 |
| Barrel Zone 4 | (° C.) | 177 | 204 | 177 | 177 | 165 |
| Barrel Zone 5 | (° C.) | 176 | 205 | 176 | 176 | 166 |
| Screen Body | (° C.) | 199 | 216 | 197 | 199 | 199 |
| Melt Temperature | (° C.) | 209 | 222 | 207 | 207 | 204 |
| Adapter | (° C.) | 199 | 215 | 198 | 199 | 199 |
| Outer Die Body | (° C.) | 199 | 216 | 199 | 199 | 199 |
| Inside Stem | (° C.) | 221 | 238 | 218 | 219 | 216 |
| Inside Die Mid | (° C.) | 221 | 233 | 220 | 219 | 218 |
| Head Pressure | (MPa) | 22 | 26 | 20 | 20 | 20 |
| Torque | HP/RPM | 0.48 | 0.44 | 0.49 | 0.49 | 0.51 |
| Specific output | Kg/h/RPM | 2.9 | 2.9 | 2.9 | 2.9 | 2.8 |

TABLE 24
Selected Properties of Films of Example 2

| | | Film Designation | | | | |
|---|---|---|---|---|---|---|
| Parameter | Units | 24 | 25 | 26 | 27 | 28 |
| Gauge (Micrometer) | (micron) | 19.1 | 19.8 | 18.8 | 15.7 | 19.3 |

1% Secant Modulus

| | | | | | | |
|---|---|---|---|---|---|---|
| MD | (MPa) | 218 | 214 | 211 | 212 | 215 |
| TD | (MPa) | 253 | 253 | 251 | 248 | 252 |

Tensile @ Yield

| | | | | | | |
|---|---|---|---|---|---|---|
| MD | (MPa) | 9.9 | 9.8 | 10.6 | 10.9 | 10.5 |
| TD | (MPa) | 10.4 | 10.5 | 11.7 | 12.1 | 11.9 |

Ultimate Tensile

| | | | | | | |
|---|---|---|---|---|---|---|
| MD | (MPa) | 70.0 | 71.4 | 71.6 | 69.9 | 70.0 |
| TD | (MPa) | 56.2 | 57.0 | 45.4 | 53.8 | 53.4 |

Ultimate Elongation

| | | | | | | |
|---|---|---|---|---|---|---|
| MD | (%) | 390 | 420 | 350 | 310 | 360 |
| TD | (%) | 655 | 660 | 580 | 630 | 620 |

Elmendorf Tear

| | | | | | | |
|---|---|---|---|---|---|---|
| MD | (g) | 285 | 234 | 318 | 372 | 350 |
| TD | (g) | 338 | 343 | 348 | 322 | 357 |
| MD | (g/micron) | 15.0 | 11.8 | 16.9 | 23.6 | 18.1 |
| TD | (g/micron) | 17.7 | 17.3 | 18.5 | 20.4 | 18.5 |

Dart Drop (Method A)

| | | | | | |
|---|---|---|---|---|---|
| (g) | 705 | 1000 | 850 | 620 | 770 |
| (g/micron) | 37.0 | 50.5 | 45.2 | 39.4 | 39.9 |

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

1. A polyethylene film having a MD 1% Secant Modulus of 220 MPa or more, and an MD Elmendorf Tear of Y g/micron, where Y≧−0.4515(Dart Drop in g/micron)+33.3 g/microns, wherein the MD Elmendorf tear is at least 11.8 g/micron.

2. The film of claim 1 wherein Y is 19.6 g/micron or more.

3. The film of claim 1 wherein Y is 23.6 g/micron or more.

4. The film of claim 1 wherein the ratio of Dart Impact (g/micron) to MD Elmendorf Tear Ratio (g/micron) is 0.95 or more.

5. The film of claim 1 wherein the TD Elmendorf Tear is 16 g/micron or more.

6. The film of claim 1 wherein the TD Elmendorf Tear is 18 g/micron or more.

7. A multilayer polyethylene film having at least three layers of an ethylene polymer having:
1) melt index of (2.16 kg, 190° C.) 1.0 or less dg/min;
2) a high load melt index (21.6 kg, 190° C.) of 35 dg/min or less,
3) a density of 0.910 to 0.945 g/cc,
4) an Mw/Mn of greater than 1 to 5, and
5) at least 5 wt % that is soluble in xylene at 60° C. or less where the soluble portion has:
i) an Mw of 150,000 g/mole more,
ii) an Mw/Mn of 2.0 or more,
iii) at least 5 mol % comonomer,
iv) an r₁r₂ value of 1.0 or less,
v) “butyls” per 1000 carbons of 15 or more; and
where each of the three layers may be the same or different ethylene polymer; and
wherein the film has:
a) a MD 1% Secant Modulus of 220 MPa or more,
b) a Dart Impact of 19 g/micron or more,
c) a MD Elmendorf Tear of 16 g/micron or more,
d) a thickness of 15 to 50 microns,
e) a Dart Impact to MD Elmendorf Tear Ratio of 0.95 to 1.15,
f) a MD to TD Elmendorf Tear Ratio of 0.9 or more.

8. The film of claim 7 wherein the film has an MD Elmendorf Tear of Y g/micron, where Y≧−0.4515(Dart Drop in g/micron)+33.3 g/microns, wherein the MD Elmendorf tear is at least 11.8 g/micron.

9. The film of claim 7 wherein the ethylene polymer is a copolymer of ethylene and one or more of butene, hexene and octene having a density of 0.920 to 0.940 g/cc.

10. A process to make a film comprising
A) selecting an ethylene polymer having:
1) melt index of (2.16 kg, 190° C.) 0.75 dg/min or less,
2) a high load melt index (21.6 kg, 190° C.) of 25 dg/min or less,
3) density of 0.910 to 0.945 g/cc,
4) an Mw/Mn of greater than 1 to 5, and
5) at least 5 wt % that is soluble in xylene at 60° C. or less where the soluble portion has:
i) an Mw of 150,000 g/mol or more,
ii) an Mw/Mn of 2.0 or more,
iii) at least 5 mol % comonomer,
iv) an r₁r₂ value of 1.0 or less,
v) “butyls” per 1000 carbons of 15 or more; and
B) extruding the ethylene polymer through a blown film die:
i) at a stretch rate of 2 sec⁻¹ or more,
ii) a processing time (die to frost line) of 2 seconds or less,
iii) a blow up ratio of 2.5 or less,
iv) a frost line height of 0.5 meters or less,
v) a die through put rate of 12.7 Kg/hr/cm of die or more, and
vi) such that three layers of ethylene polymer are formed;
C) obtaining a film having:
a) a MD 1% Secant Modulus of 220 MPa or more,
b) a Dart Impact of 19 g/micron or more,
c) a MD Elmendorf Tear of 16 g/micron or more,
d) a thickness of 15 to 50 microns,
e) a Dart Impact to MD Elmendorf Tear Ratio of 0.95 to 1.15,
f) a MD to TD Elmendorf Tear Ratio of 0.9 or more.

11. The process of claim 10 wherein the film has an MD Elmendorf Tear of Y g/micron, where Y≧−0.4515(Dart Drop in g/micron)+33.3 g/microns, wherein the MD Elmendorf tear is at least 11.8 g/micron.

12. The process of claim 10 wherein the ethylene polymer is a copolymer of ethylene and one or more of butene, hexene and octene having a density of 0.920 to 0.940 g/cc.

13. A process to make a film comprising
A) selecting an ethylene polymer having:
1) melt index of (2.16 kg, 190° C.) 0.75 dg/min or less,
2) a high load melt index (21.6 kg, 190° C.) of 25 dg/min or less,
3) density of 0.910 to 0.945 g/cc,
4) an Mw/Mn of greater than 1 to 5,
5) and from 0.5 to 25 mol % comonomer, and
6) at least 5 wt % that is soluble in xylene at 60° C. or less where the soluble portion has:
i) an Mw of 150,000 g/mol or more,
ii) an Mw/Mn of 2.0 or more,
iii) at least 5 mol % comonomer,
iv) a r₁r₂ value of 1.0 or less,
v) “butyls” per 1000 carbons of 15 or more; and
B) dissolving the ethylene polymer into xylene at a temperature of 120° C., cooling at a rate of 1° C. per minute, and then collecting the of ethylene polymer that is soluble in xylene at 60° C. or less where the soluble portion has:
i) an Mw of 150,000 g/mol or more,
ii) an Mw/Mn of 2.0 or more,
iii) at least 5 mol % comonomer,
iv) a r₁r₂ value of 1.0 or less,
v) “butyls” per 1000 carbons of 15 or more; and
C) forming the ethylene polymer into a film.

14. The process of claim 13 wherein the soluble portion comprises at least 5 mole % hexene.

15. The process of claim 13 wherein the film has an MD Elmendorf Tear of Y g/micron, where Y≧−0.4515(Dart Drop in g/micron)+33.3 g/microns, wherein the MD Elmendorf tear is at least 11.8 g/micron.

16. The process of claim 13 wherein the ethylene polymer is a copolymer of ethylene and one or more of butene, hexene and octene having a density of 0.920 to 0.940 g/cc.

17. The process of claim 13 wherein the Mw/Mn of the polymer is at least one unit less than the Mw/Mn of the soluble portion.

18. The process of claim 13 wherein the film has an MD Elmendorf Tear of at least 19.6 g/micron.

19. The process of claim 13 wherein the ethylene polymer is a copolymer of ethylene and hexene having a density of 0.920 to 0.940 g/cc.

20. A process to make a film comprising
A) selecting an ethylene polymer that is soluble in xylene at 60° C. or less, and has:
i) an Mw of 150,000 g/mol or more,
ii) an Mw/Mn of 2.0 or more,
iii) at least 5 mol % C3 to C20 comonomer,
iv) a r₁r₂ value of 1.0 or less, and
v) “butyls” per 1000 carbons or 15 or more; and
B) forming the ethylene polymer into a film.

21. The process of claim 20 wherein the comonomer comprises hexene.

22. The process of claim 20 wherein the an r₁r₂ value is less than 0.8.

23. A article of manufacture comprising at least 50 wt % of an ethylene copolymer having:
i) an Mw of 150,000 g/mol or more,
ii) an Mw/Mn of 2.0 or more,
iii) at least 5 mol % C3 to C20 comonomer,
iv) a r₁r₂ value of 1.0 or less, and
v) “butyls” per 1000 carbons or 15 or more.

24. The article of claim 23 wherein the article is a film.

25. The article of claim 23 where the article is a blown film.
